(19) United States
(12) Patent Application Publication
(10) Pub. No.: US 2025/0087895 A1
(43) Pub. Date: Mar. 13, 2025

(54) ANTENNA, COMMUNICATION DEVICE, AND COMMUNICATION SYSTEM

(71) Applicant: HUAWEI TECHNOLOGIES CO., LTD., Shenzhen (CN)

(72) Inventors: Wen DUAN, Shenzhen (CN); Dantao CAI, Dongguan (CN); Liangyong DENG, Dongguan (CN); Weihong XIAO, Dongguan (CN); Zijing DU, Xi'an (CN)

(21) Appl. No.: 18/960,469

(22) Filed: Nov. 26, 2024

Related U.S. Application Data
(63) Continuation of application No. PCT/CN2023/094440, filed on May 16, 2023.

(30) Foreign Application Priority Data
May 30, 2022 (CN) 202210602041.2

(51) Int. Cl. H01Q 19/10; H01Q 9/04; H01Q 13/10

(52) U.S. Cl. CPC H01Q 19/10; H01Q 9/0407; H01Q 13/10

(57) ABSTRACT

The present disclosure relates to antennas, communication devices, and communication systems. One example antenna includes a plurality of coupled resonators. The plurality of resonators are disposed on a side of a reflection plate. The plurality of resonators may have symmetry, and a first resonator in the plurality of resonators includes a plurality of portions with different extension directions.

### CROSS-REFERENCE TO RELATED APPLICATIONS

This application is a continuation of International Application No. PCT/CN2023/094440, filed on May 16, 2023, which claims priority to Chinese Patent Application No. 202210602041.2, filed on May 30, 2022. The disclosures of the aforementioned applications are hereby incorporated by reference in their entireties.

### TECHNICAL FIELD

Embodiments of this application relate to the antenna field and the communication field, and more specifically, to an antenna, a communication device, and a communication system.

### BACKGROUND

A communication device may separately cover a plurality of frequency bands through a plurality of antennas, to support more service requirements of an operator. In the conventional technology, an antenna may include a plurality of coupled resonators, and the plurality of resonators may interact with each other, so that the antenna has both a filtering function and a radiation function.

With development of mobile communication, higher requirements are imposed on various performance indicators of the antenna. How to improve the performance indicators of the antenna is a problem that needs to be resolved.

### SUMMARY

Embodiments of this application provide an antenna, a communication device, and a communication system, to improve performance of the antenna, so that the antenna meets more requirements.

According to a first aspect, an antenna is provided, including: a first resonator, a second resonator, and a reflection plate. The first resonator is located between the reflection plate and the second resonator, the first resonator is coupled to the second resonator, the first resonator is symmetric relative to a first plane of symmetry, the first resonator includes a plurality of portions, and extension directions of the plurality of portions are different.

In this application, the extension directions of the plurality of portions of the first resonator are different. Therefore, the first resonator may have a relatively large size in a direction perpendicular to the reflection plate. This helps increase bandwidth of the antenna. The first resonator has symmetry. This helps enable radiation generated by two mutually symmetric portions of the first resonator to counteract with each other as much as possible, and improves cross polarization performance of the antenna.

With reference to the first aspect, in some implementations of the first aspect, the first resonator includes a first portion, a second portion, and a third portion, the first portion is mechanically connected between the second portion and the third portion, the first portion is symmetric relative to the first plane of symmetry, the second portion is symmetric to the third portion relative to the first plane of symmetry, and the second portion extends from the first portion away from or toward the second resonator.

In this application, the second portion extends from the first portion away from the second resonator, the second portion may extend toward the reflection plate, and the first portion is located on a central portion of the first resonator and disposed close to the second resonator. This helps implement magnetic field coupling between the first resonator and the second resonator. The second portion extends from the first portion toward the second resonator, and the first portion is located on a central portion of the first resonator. This helps implement electric field coupling between the first resonator and the second resonator.

With reference to the first aspect, in some implementations of the first aspect, an end of the second portion away from the first portion is an open end of the first resonator.

In this application, both an end of the second portion and an end of the third portion are open ends. This helps increase a size of the antenna in a direction perpendicular to the reflection plate, and helps increase bandwidth of the antenna.

With reference to the first aspect, in some implementations of the first aspect, the first resonator further includes a fourth portion and a fifth portion, the fourth portion is mechanically connected to an end of the second portion away from the first portion, the fifth portion is mechanically connected to an end of the third portion away from the first portion, and the fourth portion is symmetric to the fifth portion relative to the first plane of symmetry.

In some embodiments, the first portion is disposed close to the reflection plate, and the fourth portion and the fifth portion are disposed close to the second resonator. The fourth portion and the fifth portion may be connected to the second resonator. This helps improve coupling strength between the first resonator and the second resonator.

In some other embodiments, the first portion is disposed close to the second resonator, and the fourth portion and the fifth portion are disposed close to the reflection plate. Therefore, a feeding location can be flexibly disposed on the fourth portion or the fifth portion of the first resonator, thereby facilitating flexible adjustment of bandwidth of the antenna.

With reference to the first aspect, in some implementations of the first aspect, the fourth portion extends from the second portion away from or close to the third portion.

In some embodiments, the fourth portion extends from the second portion away from the third portion, and the fifth portion extends from the third portion away from the second portion, so that a spacing between the fourth portion and the first plane of symmetry may be relatively large, and a spacing between the fifth portion and the first plane of symmetry may be relatively large. When the fourth portion and the fifth portion are disposed close to the second resonator, the fourth portion and the fifth portion may be coupled to two ends of the second resonator, which helps adjust a filtering effect. When the fourth portion and the fifth portion are disposed close to the reflection plate, a feeding location on the fourth portion or the fifth portion may be used to implement relatively wide bandwidth.

In some embodiments, the fourth portion extends from the second portion close to the third portion, and the fifth portion extends from the third portion close to the second portion, so that a spacing between the fourth portion and the first plane of symmetry may be relatively small, and a spacing between the fifth portion and the first plane of symmetry may be relatively small. When the fourth portion and the fifth portion are disposed close to the second resonator, the fourth portion and the fifth portion may be coupled to a central portion of the second resonator, which helps adjust a filtering effect. When the fourth portion and the fifth portion are disposed close to the reflection plate, a feeding location on the fourth portion or the fifth portion may be used to implement relatively narrow bandwidth.

In some embodiments, the first resonator further includes an eighth portion, the eighth portion is mechanically connected to the first portion, and the eighth portion is symmetric relative to the first plane of symmetry. The eighth portion may be disposed close to the center of the second resonator. This helps optimize filtering performance.

In some embodiments, the first resonator further includes a ninth portion and a tenth portion, the ninth portion is mechanically connected to the second portion, the tenth portion is mechanically connected to the third portion, the tenth portion extends toward the second portion, and the ninth portion is symmetric to the tenth portion relative to the first plane of symmetry. In an embodiment, the ninth portion extends toward the third portion. Therefore, this helps improve cross polarization performance or polarization isolation.

In some embodiments, any one of the following is configured to receive feeding: the first portion, the second portion, and the third portion.

With reference to the first aspect, in some implementations of the first aspect, the second portion or the third portion is:
perpendicular to the first portion; or
oblique to the first portion.

In some embodiments, the plurality of portions of the first resonator may be of a strip structure, and the strip structure may be a straight strip structure or a curved strip structure.

Angles of the second portion and the third portion relative to the first portion are adjusted, so that a distance between a feeding location on the second resonator and the first plane of symmetry can be adjusted. If the distance between the feeding location and the first plane of symmetry is relatively large, it helps enable the antenna to have relatively large bandwidth. If the distance between the feeding location and the first plane of symmetry is relatively small, it helps enable the antenna to have relatively small bandwidth.

With reference to the first aspect, in some implementations of the first aspect, the antenna further includes a third resonator, the third resonator is symmetric relative to the first plane of symmetry, the third resonator is disposed on a side of the first resonator and away from the second resonator, and the third resonator is coupled to the first resonator.

In this application, in the antenna, a plurality of resonators are disposed between the reflection plate and the second resonator that serves as a radiating element, and the plurality of resonators are symmetric relative to a same plane of symmetry. This helps improve filtering performance of the antenna. In other words, this helps reduce strength of a signal received by the antenna in a specified filtering frequency band.

In some embodiments, the third resonator is configured to receive feeding.

With reference to the first aspect, in some implementations of the first aspect, the third resonator is further coupled to the second resonator.

In this application, the third resonator may be coupled to both the first resonator and the second resonator. Therefore, this helps enable the antenna to have relatively many coupling modes, and helps improve filtering performance of the antenna.

With reference to the first aspect, in some implementations of the first aspect, the third resonator includes a sixth portion and a seventh portion, extension directions of the sixth portion and the seventh portion are different, the sixth portion is coupled to the first resonator, and the seventh portion is configured to receive feeding.

In this application, the third resonator includes a plurality of portions with different extension directions. This helps increase a size of the antenna in a direction perpendicular to the reflection plate, and helps enable the antenna to have relatively wide bandwidth. A feeding location on the seventh portion is adjusted, so that bandwidth of the antenna can be adjusted.

In some embodiments, the sixth portion is coupled to the second portion, the third resonator further includes an eleventh portion, the eleventh portion is symmetric to the sixth portion relative to the first plane of symmetry, and the eleventh portion is coupled to the third portion. In other words, the two portions of the third resonator that are symmetrically disposed may be respectively coupled to the two portions of the first resonator. The central portion of the second resonator may be coupled to the central portion of the first resonator. This helps increase bandwidth of the antenna.

In some embodiments, the seventh portion is coupled to the first portion, the third resonator further includes a twelfth portion, the twelfth portion is symmetric to the seventh portion relative to the first plane of symmetry, and the twelfth portion is coupled to the first portion. In other words, the two portions of the third resonator that are symmetrically disposed may be coupled to the same portion of the first resonator. Two ends of the third resonator may be coupled to the central portion of the first resonator. This helps improve filtering performance of the antenna. With reference to the first aspect, in some implementations of the first aspect, the second resonator is symmetric relative to a second plane of symmetry.

In this application, the second resonator has symmetry. This helps improve overall performance of the antenna.

With reference to the first aspect, in some implementations of the first aspect, the first plane of symmetry and the second plane of symmetry are coplanar.

In this application, the entire antenna is symmetric relative to the same plane of symmetry. This helps further improve overall performance of the antenna. For example, this helps improve cross polarization performance of the antenna. For another example, when the antenna is a dual-polarized antenna, this helps improve polarization isolation of the antenna.

With reference to the first aspect, in some implementations of the first aspect, projection is performed in a direction parallel to the first plane of symmetry and perpendicular to the reflection plate, and a projection region of the first resonator at least partially overlaps a projection region of the second resonator.

In this application, the projection is performed in the direction parallel to the first plane of symmetry and perpendicular to the reflection plate, and the projection region of the first resonator at least partially overlaps the projection region of the second resonator. This helps enable energy to be propagated between the first resonator and the second resonator in the direction perpendicular to the reflection plate as much as possible, and helps reduce an energy loss between the first resonator and the second resonator.

With reference to the first aspect, in some implementations of the first aspect, projection is performed in the direction parallel to the first plane of symmetry and perpendicular to the reflection plate, and the projection region of the first resonator is located inside the projection region of the second resonator.

In this application, the projection area of the second resonator is relatively large. In one aspect, this helps increase energy received by the second resonator from the first resonator. In another aspect, capabilities of the second resonator to radiate a signal and receive a signal can be relatively strong. Therefore, this helps improve a gain of the antenna.

In some embodiments, the second resonator is a plate. A length l of the second resonator is adjusted, so that an operating frequency band of the antenna can be adjusted. A width/of the second resonator is adjusted, so that coupling strength between the first resonator and the second resonator can be adjusted, and further, bandwidth of the antenna can be adjusted.

In some embodiments, the length and the width of the second resonator are the same.

The second resonator may be of a patch structure.

In some embodiments, the second resonator has a first slot and a second slot, the first slot is in communication with the second slot, and the projection region of the first resonator on the second resonator includes a portion located outside the first slot and the second slot, where the first slot is symmetric to the second slot relative to the second plane of symmetry; or both the first slot and the second slot are symmetric relative to the second plane of symmetry.

The second resonator is provided with a plurality of slots. This helps reduce a physical length of the second resonator when an electrical length of the second resonator remains unchanged. A longer slot of the second resonator indicates a smaller physical length of the second resonator. Therefore, this helps reduce space occupied by the second resonator.

In some embodiments, the second resonator further has an opening, the opening is in communication with an end of the first slot away from the second slot, and the opening is perpendicular to the first slot.

The second resonator is further provided with the opening, and a distance between the opening and the plane of symmetry of the second resonator is relatively long. Therefore, this helps reduce a physical length while ensuring coupling strength between the second resonator and the first resonator.

In some embodiments, the second resonator includes a first extension portion and a second extension portion, the first extension portion is connected to the second extension portion, and the first extension portion is symmetric to the second extension portion relative to the second plane of symmetry, a width of the first extension portion gradually increases from an end, of the first extension portion, close to the second extension portion to an end of the first extension portion away from the second extension portion.

The second resonator may have a relatively small width at the central location. This helps reduce a physical length of the second resonator when an electrical length of the second resonator remains unchanged, and helps reduce space occupied by the second resonator and the antenna in a length direction.

In some embodiments, the second resonator further includes a third extension portion and a fourth extension portion, the first extension portion, the second extension portion, the third extension portion, and the fourth extension portion intersect in a same region, and both the third extension portion and the fourth extension portion are symmetric relative to the second plane of symmetry. The antenna further includes a fifth resonator, the fifth resonator is coupled to the second resonator, the fifth resonator is symmetric relative to the second plane of symmetry, and a polarization direction of the fifth resonator and a polarization direction of the first resonator are orthogonal to each other.

The second resonator further includes the third extension portion and the fourth extension portion, and the antenna further includes the fifth resonator. This helps implement dual polarization of the antenna.

In some embodiments, the second resonator includes a first plate, a second plate, and a third plate, the first plate is symmetric relative to the second plane of symmetry, the first plate has a first plate end portion and a second plate end portion, the second plate is disposed in a region of the first plate close to the first plate end portion, the third plate is disposed in a region of the first plate close to the second plate end portion, the second plate is symmetric to the third plate relative to the second plane of symmetry, and the second plate is parallel or perpendicular to the first plate.

The second plate is perpendicular to the first plate, and a width of the first plate is different from a width of the second plate.

In an embodiment, the width of the second plate may be greater than the width of the first plate. The second resonator has a relatively large width at a location close to an open end, and the second resonator has a relatively small width at the central location. Therefore, this helps reduce a physical length of the second resonator when an electrical length of the second resonator remains unchanged, and helps reduce space occupied by the second resonator and the antenna in a length direction.

In another embodiment, the width of the second plate may be less than the width of the first plate, so that a physical length of the second resonator is increased when an electrical length of the second resonator remains unchanged. Because the second resonator has a relatively large width at the central location, coupling strength between the second resonator and the central portion of the first resonator can be relatively strong.

The second plate is perpendicular to the first plate, which means that the central region of the second resonator may be a plate, and an edge region of the second resonator may have a protrusion. This helps reduce a size of the second resonator in a length direction and/or a width direction, and helps reduce overall occupied space of the antenna. In an embodiment, the second plate extends toward the second resonator. This helps reduce a size of the antenna in a height direction.

With reference to the first aspect, in some implementations of the first aspect, the antenna further includes a fourth resonator, the fourth resonator is located on a side of the second resonator away from the first resonator, and the fourth resonator is coupled to the second resonator.

In this application, the fourth resonator may serve as a radiating element of the antenna together with the second resonator. Therefore, this helps improve a gain of the antenna. In this embodiment provided in this application, the antenna may include a plurality of radiating elements, and the plurality of radiating elements may be coupled to each other.

With reference to the first aspect, in some implementations of the first aspect, the antenna has a first feeding location and a second feeding location, and the first feeding location is symmetric to the second feeding location relative to the first plane of symmetry.

In this application, the antenna may receive a differential feeding signal by using the first feeding location and the second feeding location. Therefore, this helps implement differential feeding of the antenna.

With reference to the first aspect, in some implementations of the first aspect, an electrical length of the first resonator is (¼ to ¾)λ, where λ is a wave length corresponding to a center frequency of an operating frequency band of the antenna.

In this application, the electrical length of the first resonator is properly designed. This helps enable the antenna to work in the operating frequency band.

With reference to the first aspect, in some implementations of the first aspect, an electrical length of the second resonator is (¼ to ¾)λ, where λ is the wave length corresponding to the center frequency of the operating frequency band of the antenna.

In some embodiments, a difference between the electrical length of the first resonator and the electrical length of the second resonator is less than λ/4, where λ is the wave length corresponding to the center frequency of the operating frequency band of the antenna. Therefore, this helps enable the antenna to work in the operating frequency band.

In some embodiments, a spacing between the first resonator and the second resonator is less than λ/8, where λ is the wave length corresponding to the center frequency of the operating frequency band of the antenna. Therefore, this helps enable energy transfer efficiency between the first resonator and the second resonator to be relatively high.

In some embodiments, a spacing between the second resonator and the reflection plate is less than 7λ/10, where λ is the wave length corresponding to the center frequency of the operating frequency band of the antenna. Therefore, this helps enable that a reflection function of the reflection plate can be fully used.

In this application, the electrical length of the second resonator is properly designed. This helps enable the antenna to work in the operating frequency band.

With reference to the first aspect, in some implementations of the first aspect, the second resonator is a radiating element of the antenna.

In this application, the antenna may radiate a signal by using the second resonator.

With reference to the first aspect, in some implementations of the first aspect, the antenna further includes a fifth resonator, the fifth resonator is coupled to the second resonator, the fifth resonator is symmetric relative to a third plane of symmetry, the third plane of symmetry is perpendicular to the first plane of symmetry, and a polarization direction of the fifth resonator and a polarization direction of the first resonator are orthogonal to each other. Therefore, this helps implement dual polarization of the antenna by using the fifth resonator and the first resonator.

According to a second aspect, an antenna is provided, including a fifth resonator, a sixth resonator, a seventh resonator, and a reflection plate. The fifth resonator is symmetric to the sixth resonator relative to a first plane of symmetry, the reflection plate and the seventh resonator are located on two sides of the fifth resonator, the reflection plate and the seventh resonator are located on two sides of the sixth resonator, the fifth resonator is coupled to the seventh resonator, the sixth resonator is coupled to the seventh resonator, and the fifth resonator includes a plurality of portions with different extension directions.

In this application, two independent resonators are symmetrically disposed, and the resonator have a relatively large size in a direction perpendicular to the reflection plate. This helps increase bandwidth of an antenna, and further helps enable radiation generated by the two independent resonators that are symmetrically disposed to counteract with each other as much as possible, and improve cross polarization performance of the antenna.

According to a third aspect, a communication device is provided, including the antenna according to any one of the implementations of the first aspect or the second aspect.

According to a fourth aspect, a communication system is provided, including: the antenna according to any one of the implementations of the first aspect or the second aspect; and a signal processing apparatus, where the signal processing apparatus is configured to perform signal transmission through the antenna.

### BRIEF DESCRIPTION OF DRAWINGS

FIG. 1 is a diagram of a system architecture to which an embodiment of this application is applicable;

FIG. 2 is a diagram of a structure of a communication device according to an embodiment of this application;

FIG. 3 is a diagram of a structure of an antenna system according to an embodiment of this application;

FIG. 4 is a diagram of a structure of an antenna according to an embodiment of this application;

FIG. 5 is a diagram of a structure of an antenna according to an embodiment of this application;

FIG. 6 is a diagram of a structure of an antenna according to an embodiment of this application;

FIG. 7 is a diagram of a structure of an antenna according to an embodiment of this application;

FIG. 8 is a diagram of a structure of an antenna according to an embodiment of this application;

FIG. 9 is a three-dimensional diagram of an antenna according to an embodiment of this application;

FIG. 10 is a three-dimensional diagram of an antenna according to an embodiment of this application;

FIG. 11 is a three-dimensional diagram of a resonator 110 and a resonator 130 in the embodiment shown in FIG. 10;

FIG. 12 is a diagram of a structure of an antenna according to an embodiment of this application;

FIG. 13 is a diagram of a structure of an antenna according to an embodiment of this application;

FIG. 14 is a diagram of a structure of an antenna according to an embodiment of this application;

FIG. 15 is a diagram of a structure of an antenna according to an embodiment of this application;

FIG. 16 is a diagram of a structure of an antenna according to an embodiment of this application;

FIG. 17 is a diagram of a structure of an antenna according to an embodiment of this application;

FIG. 18 is a diagram of a structure of an antenna according to an embodiment of this application;

FIG. 19 is a diagram of a structure of an antenna according to an embodiment of this application;

FIG. 20 is a three-dimensional diagram of an antenna according to an embodiment of this application;

FIG. 21 is a three-dimensional diagram of an antenna according to an embodiment of this application;

FIG. 22 is a three-dimensional diagram of an antenna according to an embodiment of this application;

FIG. 23 is a three-dimensional diagram of an antenna according to an embodiment of this application;

FIG. 24 is a three-dimensional diagram of an antenna according to an embodiment of this application;

FIG. 25 is a three-dimensional diagram of an antenna according to an embodiment of this application;

FIG. 26 is a three-dimensional diagram of an antenna according to an embodiment of this application;

FIG. 27 is a three-dimensional diagram of an antenna according to an embodiment of this application;

FIG. 28 is a three-dimensional diagram of an antenna according to an embodiment of this application;

FIG. 29 is a diagram of a structure of an antenna according to an embodiment of this application;

FIG. 30 is a three-dimensional diagram of the antenna shown in FIG. 29;

FIG. 31 is a diagram of a structure of an antenna according to an embodiment of this application;

FIG. 32 is a three-dimensional diagram of the antenna shown in FIG. 31;

FIG. 33 is a diagram of a structure of an antenna according to an embodiment of this application;

FIG. 34 is a diagram of a structure of an antenna according to an embodiment of this application;

FIG. 35 is a diagram of a structure of an antenna according to an embodiment of this application;

FIG. 36 is a three-dimensional diagram of the antenna shown in FIG. 35;

FIG. 37 is a diagram of reflection performance of an antenna according to an embodiment of this application; and

FIG. 38 is a diagram of isolation of an antenna according to an embodiment of this application.

### DESCRIPTION OF EMBODIMENTS

The following describes technical solutions of embodiments in this application with reference to accompanying drawings.

Terms used in the following embodiments are merely intended to describe specific embodiments, but are not intended to limit this application. The term “and/or” is for describing an association relationship between associated objects and indicates that three relationships may exist. For example, A and/or B may indicate the following cases: Only A exists, both A and B exist, and only B exists, where A and B may be singular or plural. The character “/” generally indicates an “or” relationship between the associated objects. Reference to “an embodiment”, “some embodiments”, or the like described in this specification indicates that one or more embodiments of this application include a specific characteristic, structure, or feature described with reference to the embodiment. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. A plurality of embodiments provided in this application may be combined to obtain a new embodiment. For example, some or all features in Embodiment A and some or all features in Embodiment B may be combined to obtain a new embodiment. The new embodiment obtained by combining the plurality of embodiments also falls within the technical scope disclosed in this application. The terms “include”, “comprise”, and “have”, and their variants all mean “including but not limited to”, unless otherwise specifically emphasized in another manner.

For ease of understanding, the following explains and describes related technical terms in embodiments of this application.

### 1. Wave Length

The wave length may be a propagation distance of a wave in a periodicity. In a propagation direction of the wave, after a phase of the wave changes by 2π, the propagation distance of the wave may be the wave length. λ=VT, where λ is the wave length, V is a wave velocity, and T is a wave periodicity.

### 2. Center Frequency

The center frequency is an intermediate value of a sum of the lowest frequency and the highest frequency of an operating frequency band, that is, f₀=(f_{L}+f_{H})/2, where f₀ indicates the center frequency, f_{L}, indicates the lowest frequency of the operating frequency band, and f_{H} indicates the highest frequency of the operating frequency band. When the operating frequency band includes a plurality of sub-bands, for a definition of a center frequency of each sub-band, reference may be made to the definition of the operating frequency band, that is, the operating frequency band is replaced with an operating sub-band. On this basis, the center frequency of the entire operating frequency band may be an intermediate value of a sum of the lowest frequencies and the highest frequencies of all sub-bands.

### 3. Radiating Element

The radiating element may also be referred to as an antenna element, an oscillator, or the like. The radiating element is a basic unit that forms an antenna array. The radiating element can effectively transmit or receive a radio wave.

### 4. Filter and Resonator

The filter includes one or more resonators, and has a frequency selection characteristic and an energy storage function. When the filter includes a plurality of resonators, the filter may be considered as a device formed through coupling of the plurality of resonators. Common resonators include: a transmission line resonator, a rectangular waveguide resonant cavity, a cylindrical waveguide resonant cavity, a dielectric cavity resonator, and the like.

### 5. Open End

The open end may be a region close to or located at an end of a transmission line. In some embodiments, in a direction from the end of the transmission line to a center of the transmission line, an electrical length of the open end may be less than or equal to λ/8 starting from the end of the transmission line, where λ may be a wave length corresponding to a center frequency of an antenna or the transmission line.

### 6. Reflection Plate

The reflection plate may also be referred to as a ground plate, a bottom plate, an antenna panel, a metal reflective surface, or the like. The reflection plate is configured to improve sensitivity of receiving an antenna signal, and reflect and aggregate the antenna signal to a receiving point, to enhance receiving and transmitting capabilities of an antenna. In addition, the reflection plate blocks and shields interference on the antenna caused by an electromagnetic wave from the back of the reflection plate (in a direction opposite to a radiation direction of the antenna).

### 7. Feeder Network

The feeder network feeds a signal to a radiating element based on a specific amplitude and phase, or sends, to a signal processing unit of a communication device based on a specific amplitude and phase, a radio signal received from the radiating element. The feeder network generally includes a controlled impedance transmission line. In some embodiments, the feeder network may further include a phase shifter. In some embodiments, the feeder network may further include components such as a combiner and the filter mentioned above.

### 8. Mechanical Connection

The mechanical connection may be a case in which two parts are structurally connected, there is a structural connection relationship between the two parts, and the two parts are not in a complete disconnection relationship in structure. The mechanical connection may be classified into a direct mechanical connection and an indirect mechanical connection.

The direct mechanical connection may mean that a part A is directly connected to a part B, and the part A may be in direct touch with the part B. In some embodiments, the part A and the part B are directly connected through one or more of the following: soldering, clamping, riveting, bonding, abutting, and locking (such as screw fastening).

The indirect mechanical connection may mean that the part A is connected to the part B through one or more other parts. For example, the part A is connected to the part B through a part C. The part A may be directly mechanically connected to the part C, and/or the part B may be directly mechanically connected to the part C.

### 9. Electrical Connection

The electrical connection may also be referred to as an electric connection. The electrical connection may mean that energy can be propagated between two parts. For example, an electrical signal may be propagated between the two parts. For another example, energy may be propagated between the two parts by using an induced electric or magnetic field. The electrical connection may be classified into a direct electrical connection and an indirect electrical connection.

The direct electrical connection may mean that there is a mechanical connection relationship between a part A and a part B, and energy can be propagated between the part A and the part B. In some embodiments, the part A and the part B may be electrical elements. For example, the part A and the part B may be conductors. A part connected between the part A and the part B may also be an electrical element.

The indirect electrical connection may also be referred to as coupling. Energy transmission or exchange may be implemented through the coupling. In some embodiments, that the part A is coupled to the part B may mean that a distance between the part A and the part B is relatively short, the part A and the part B may not be directly mechanically connected, and there is no interference medium between the part A and the part B. For example, there is no conductor medium interference between the part A and the part B, and energy radiated by the part A may be transmitted to the part B by using space between the part A and the part B. In an embodiment, an open end of the part A is coupled to the part B. This may be considered as electric field coupling. In another embodiment, a center of the part A is coupled to the part B. This may be considered as magnetic field coupling.

### 10. Physical Length and Electrical Length

In an extension direction of a part, the part has a first end and a second end, and a length of an extension track from the first end to the second end may be a physical length of the part. The physical length of the part may correspond to an electrical length of the part, that is, d_{I}=d₀*T/T₀, where d_{I} represents the electrical length of the part, d₀ represents the physical length of the part, T represents time of propagating an electromagnetic wave through the part, and T₀ represents time of propagating the electromagnetic wave in free space. In some embodiments, a part may include a plurality of portions with different extension directions, a physical length of the part may be a sum of physical lengths of the plurality of portions, and an electrical length of the part may be a sum of electrical lengths of the plurality of portions.

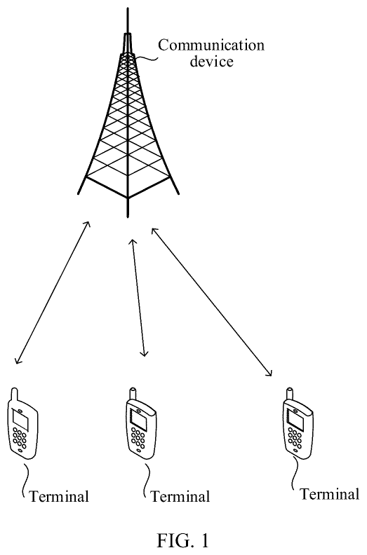

FIG. 1 is a diagram of an example of a system architecture to which an embodiment of this application is applicable. As shown in FIG. 1, the system architecture may include a communication device and a terminal. Wireless communication may be implemented between the communication device and the terminal. The communication device may also be referred to as a base station, an access network device, or the like. The communication device may be located in a base station subsystem (BSS), a terrestrial radio access network (UTRAN), or an evolved terrestrial radio access network (E-UTRAN), and is configured to perform cell coverage of a signal, to implement communication between the terminal and a wireless network. Specifically, the communication device may be a base transceiver station (BTS) in a global system for mobile communications (GSM) or a code division multiple access (CDMA) system, may be a NodeB (NB) in a wideband code division multiple access (WCDMA) system, may be an evolved NodeB (eNB or eNodeB) in a long term evolution (LTE) system, or may be a radio controller in a cloud radio access network (CRAN) scenario. Alternatively, the communication device may be a relay station, an access point, a vehicle-mounted device, a wearable device, a gNode (gNodeB or gNB) in a new radio (NR) system, an access network device in a future evolved network, or the like. This is not limited in embodiments of this application.

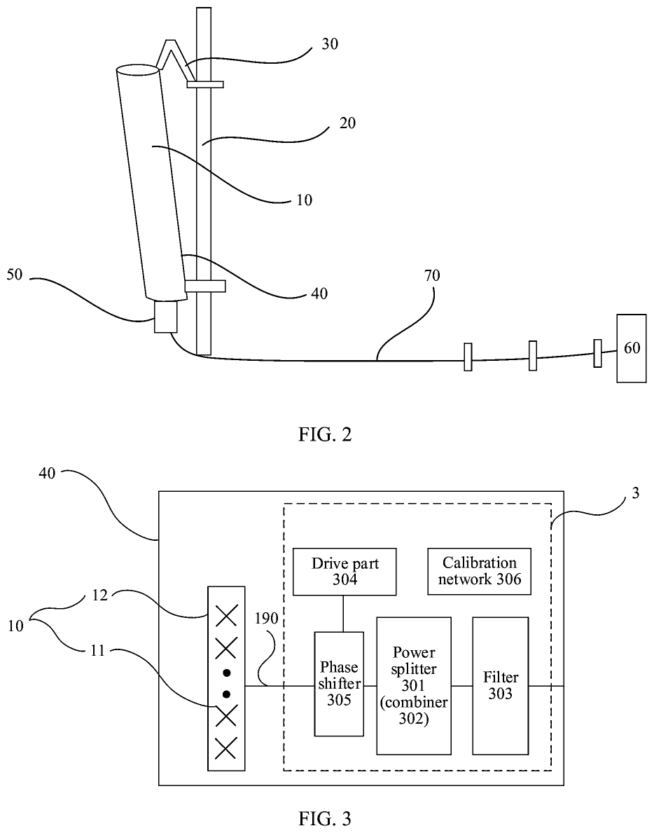

The communication device may be configured with an antenna system to implement signal transmission in space. FIG. 2 is a diagram of an application scenario in which the communication device shown in FIG. 1 is configured with an antenna system. The antenna system shown in FIG. 2 may include structures such as an antenna 10 and an antenna support 30. In some embodiments provided in this application, for example, the antenna system may be fastened to a pole (in some scenarios, the pole 20 may also be referred to as a tower) 20 of the communication device through the antenna support 30.

In some embodiments, the antenna system may include a radome 40, and the radome 40 covers the antenna 10. The radome 40 has a good electromagnetic wave penetration characteristic in terms of electrical performance, and can withstand impact of an external harsh environment in terms of mechanical performance, so that the antenna 10 can be protected from the impact of the external environment. For example, the radome 40 can reduce wind load (wind load, which is pressure generated by air flow on an engineering structure, and is also referred to as wind dynamic pressure, wind load, or the like) borne by the antenna 10. In the embodiment shown in FIG. 2, the radome 40 may be mounted on the pole 20 through the antenna support 30, so that the antenna 10 receives or transmits a signal. For example, the radome 40 may be disposed on a radiating element of the antenna 10 in a manner of electroplating, spraying, or the like.

In the embodiment shown in FIG. 2, the communication device may further include a signal processing apparatus. The signal processing apparatus may be configured to perform signal transmission through the antenna 10, including: The signal processing apparatus sends a signal through the antenna 10, and/or the signal processing apparatus receives a signal through the antenna 10. In some embodiments, the signal processing apparatus may include a radio frequency processing unit 50 and a baseband processing unit 60. The baseband processing unit 60 may be electrically connected to the antenna 10 through the radio frequency processing unit 50. In some embodiments, the radio frequency processing unit 50 may also be referred to as a remote radio unit (RRU), and the baseband processing unit 60 may also be referred to as a baseband unit (BBU). The radio frequency processing unit 50 may be electrically connected to the baseband processing unit 60 through a transmission line 70.

It should be noted that FIG. 2 is only an example of a location relationship between the radio frequency processing unit 50 and the antenna 10. In some other embodiments, alternatively, both the radio frequency processing unit 50 and the baseband processing unit 60 may be located at a remote end of the antenna 10.

FIG. 3 is a diagram of a structure of an antenna system according to an embodiment of this application.

An antenna 10 may include a radiating element 11 and a reflection plate 12. The radiating element 11 may be a unit that constitutes a radiating element array, and can effectively radiate and/or receive an antenna signal. Frequencies of different radiating elements 11 may be the same or different. The radiating element 11 is usually placed on a side of the reflection plate 12.

In the antenna system, a feeder network 3 is located between the radiating element 11 and a power amplifier of a radio frequency processing unit 50. The feeder network 3 may feed the radiating element 11 through a transmission line 190, for example, provide a specific power and phase for the radiating element 11. For example, the feeder network 3 may include a power splitter 301 (or a combiner 302) that can be used in a forward direction or in a reverse direction, and is configured to divide one signal into a plurality of signals or combine a plurality of signals into one signal. The feeder network 3 may further include a filter 303, configured to filter out an interference signal. For a remote electrical tilt antenna, the feeder network 3 may further include a drive part 304 to implement different radiation beam directions, and a phase shifter 305 to change a signal radiation maximum direction. In some cases, the phase shifter 305 may further have a function of the power splitter 301 (or the combiner 302), so that the power splitter 301 (or the combiner 302) can be omitted in the feeder network 3. In some embodiments, the feeder network 3 may further include a calibration network 306, to obtain a needed calibration signal. Different components included in the feeder network 3 may be electrically connected through the transmission line and a connector. It should be noted that the power splitter 301 (or the combiner 302) may be located inside or outside a radome 40, and an electrical connection relationship between different parts mentioned above is not unique. FIG. 3 shows only a possible location relationship and electrical connection manner of the parts.

The antenna should meet use requirements in terms of bandwidth, a gain, isolation, a reflection coefficient, and filtering performance. This application provides a new antenna, to enable the antenna to have relatively good radio frequency performance, so that the antenna meets use requirements in a plurality of aspects.

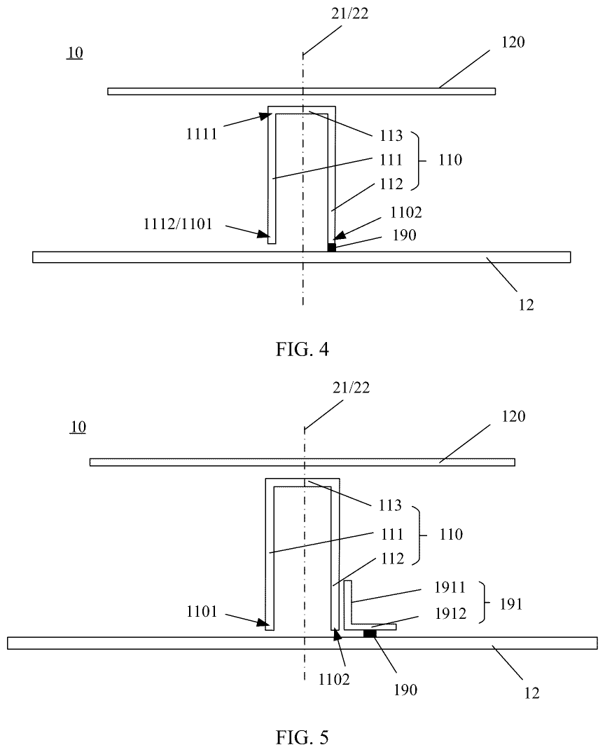

FIG. 4 is a diagram of a structure of an antenna 10 according to an embodiment of this application. The diagram of the structure shown in FIG. 4 may be a front view of the antenna 10. The antenna 10 provided in this application may be, for example, used in a frequency division duplex (FDD) multiple-in multiple-out (MIMO) array, a time division duplex (TDD) MIMO array, or an active antenna unit (AAU) frequency division antenna array.

The antenna 10 may include a plurality of resonators. The plurality of resonators may include a resonator 110, a resonator 120, and a reflection plate 12. The resonator 110 may be located between the resonator 120 and the reflection plate 12. The resonator 110 is coupled to the resonator 120, so that the resonator 110 can propagate energy to the resonator 120, and the resonator 120 may propagate energy to the resonator 110.

In a possible case, the resonator 110 may receive a signal from the feeder network 3 shown in FIG. 3, and transfer the signal to the resonator 120 by using a coupling relationship between the resonator 110 and the resonator 120, so that the antenna 10 can transmit the signal. In another possible case, the resonator 120 may receive a signal from another communication device, and transfer the signal to the resonator 110 by using a coupling relationship between the resonator 110 and the resonator 120, so that the antenna 10 can receive the signal from the another communication device.

In some embodiments, the resonator 120 may correspond to the radiating element 10 shown in FIG. 3. A proportion of energy radiated by the resonator 120 to total energy radiated by the antenna 10 may be relatively large. In some embodiments, the resonator 110 can also radiate energy, and a proportion of the energy radiated by the resonator 110 to the total energy radiated by the antenna 10 may be less than the proportion of the energy radiated by the resonator 120 to the total energy radiated by the antenna 10.

The resonator 120 may be disposed on a side of the resonator 110 by using an insulation support structure (not shown in FIG. 4). In some embodiments, the insulation support structure may be an insulation stub connected between the resonator 110 and the resonator 120. In some other embodiments, the insulation support structure may be an insulation plate disposed between the resonator 110 and the resonator 120, and the insulation plate may separate the resonator 110 and the resonator 120.

In the embodiment shown in FIG. 4, the resonator 110 is symmetric relative to a plane of symmetry 21. In other words, the resonator 110 is of a mirror-symmetric structure. The resonator 110 includes a plurality of portions, and extension directions of the plurality of portions are different. The extension directions of the plurality of portions of the resonator 110 are different. Therefore, the resonator 110 may have a relatively large size in a direction perpendicular to the reflection plate 12. This helps increase bandwidth of the antenna 10. The resonator 110 has symmetry. This helps enable radiation generated by two mutually symmetric portions of the resonator 110 to counteract with each other as much as possible, and improves cross polarization performance of the antenna 10.

The resonator 110 may include a portion 111 and a portion 112, and the portion 111 may be symmetric to the portion 112 relative to the plane of symmetry 21.

In some embodiments, the portion 111 or the portion 112 of the resonator 110 may be of a strip structure. In an embodiment, the portion 111 or the portion 112 may be of a straight strip structure. In another embodiment, the portion 111 or the portion 112 may be of a curved strip structure. It should be noted that the plurality of portions of the resonator 110 each may include only a portion of the straight strip structure, may include only a portion of the curved strip structure, or may include both the portion of the straight strip structure and the portion of the curved strip structure.

In some embodiments, as shown in FIG. 4, an extension direction of the portion 111 may be parallel to the plane of symmetry 21. Because the portion 111 may be symmetric to the portion 112 relative to the plane of symmetry 21, an extension direction of the portion 112 may be parallel to the plane of symmetry 21.

In some other embodiments, an extension direction of the portion 111 may be oblique to the plane of symmetry 21. In other words, there is an included angle between the portion 111 and the plane of symmetry 21. Because the portion 111 may be symmetric to the portion 112 relative to the plane of symmetry 21, an extension direction of the portion 112 may be oblique to the plane of symmetry 21, and extension directions of the portion 111 and the portion 112 are different.

In some embodiments, with reference to the foregoing two embodiments, the resonator 110 may further include a portion 113, and the portion 113 may be mechanically connected between the portion 111 and the portion 112. The portion 113 may be symmetric relative to the plane of symmetry 21. An extension direction of the portion 113 is different from both the extension direction of the portion 111 and the extension direction of the portion 112. The extension direction of the portion 113 may be perpendicular to the plane of symmetry 21.

The following describes a definition of the extension direction in this application by using the portion 111 of the resonator 110 as an example. For related descriptions of an extension direction of any portion of any resonator mentioned in this application, refer to related descriptions of the extension direction of the portion 111. The portion 111 may have an end 1111 and an end 1112. A straight line passing through the end 1111 and the end 1112 may represent the extension direction of the portion 111.

In some embodiments provided in this application, the resonator 110 shown in FIG. 4 may be obtained by performing processes such as soldering, bending, and deep drawing on a raw plate material. In this application, the soldering process may mean that solder is melted through heating between two raw plate materials at a high temperature, and is cured after cooling, so that the two raw plate materials can be fastened. In this application, the bending process may be a process of changing an included angle between two plates on two sides of a specified bending region by using a bending tool (such as a bending included angle or a bending mould), to bend a raw plate-like material in the specified bending region. In this application, the deep drawing process may be a process of processing, by using a deep drawing mould, a raw plate-like material into a tube-shaped part having an opening.

In the embodiment shown in FIG. 4, the portion 111 may be directly mechanically connected to the portion 113, and the portion 112 may be directly mechanically connected to the portion 113. An end of the portion 111 away from the portion 113 may be an open end 1101 of the resonator 110, and an end of the portion 112 away from the portion 113 may be an open end 1102 of the resonator 110. The open end 1101 and the open end 1102 of the resonator 110 may be disposed close to the reflection plate 12 and away from the resonator 120, and the portion 113 of the resonator 110 may be disposed away from the reflection plate 12 and close to the resonator 120. The resonator 110 and the resonator 120 may be coupled through the portion 113.

The portion 113 is symmetric relative to the plane of symmetry 21, and the portion 113 may be a central portion of the resonator 110. Therefore, the coupling between the resonator 110 and the resonator 120 may correspond to magnetic field coupling. Therefore, this helps flexibly adjust high-frequency rejection performance or low-frequency rejection performance of the antenna 10.

The open end 1101 and the open end 1102 of the resonator 110 may be disposed close to the reflection plate 12, to help the antenna 10 receive feeding. In some embodiments, with reference to FIG. 3 and FIG. 4, the transmission line 190 of the feeder network 3 may feed power at the open end 1101, near the open end 1101, at the open end 1102, or near the open end 1102, to help the antenna 10 receive a feeding signal.

In some embodiments, with reference to FIG. 3 and FIG. 4, the transmission line 190 in the feeder network 3 may be directly electrically connected to the open end 1102, so that the feeder network 3 feeds the antenna 10. In other words, the open end 1102 may be configured to receive feeding. The feeding manner shown in FIG. 4 may be direct feeding. In a possible case, the open end 1102 may be a feeding port of the antenna 10.

In some other embodiments, the antenna 10 may feed power in a coupling manner, and this feeding manner may be coupled feeding. As shown in FIG. 5, the antenna 10 may further include an electrical connector 191, and the electrical connector 191 may include an electrical connection portion 1911 and an electrical connection portion 1912. The electrical connection portion 1911 may be disposed close to the portion 112 of the resonator 110, so that the electrical connection portion 1911 can be coupled to the portion 112. With reference to FIG. 3 and FIG. 5, the electrical connection portion 1912 may be electrically connected to the transmission line 190 of the feeder network 3. Therefore, the feeder network 3 can feed the antenna 10 at a location of the portion 112 relatively away from the open end 1102. In other words, the location of the portion 112 relatively away from the open end 1102 may be configured to receive feeding. Therefore, this helps adjust a feeding location of the antenna 10, and further helps adjust bandwidth of the antenna 10. In a possible case, a part that is of the portion 112 and that is coupled to the electrical connector 191 may be a feeding port of the antenna 10.

In some possible scenarios, an electrical length of the electrical connector 191 may be less than or equal to λ/2, where λ is a wave length corresponding to a center frequency of an operating frequency band of the antenna. An electrical length of the electrical connection portion 1911 may be less than or equal to λ/4. In a possible case, the electrical length of the electrical connection portion 1911 may be equal to an electrical length of the electrical connection portion 1912.

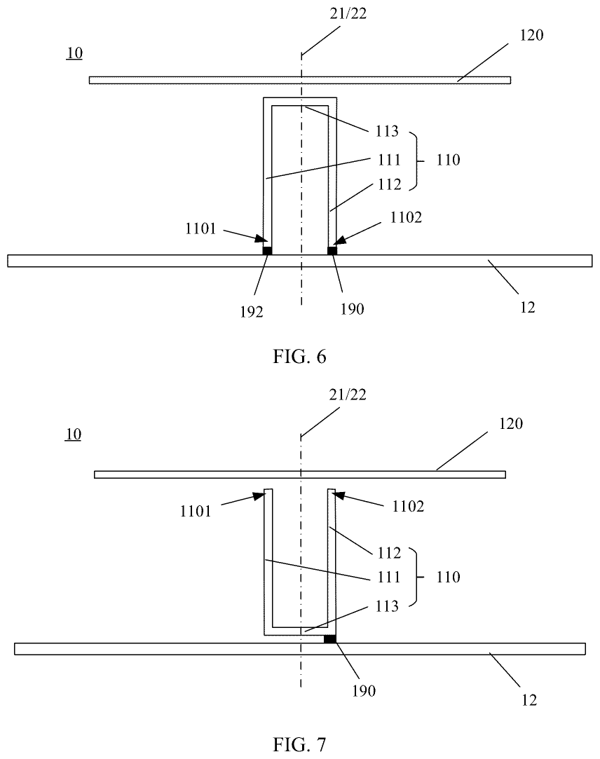

In still some embodiments, with reference to FIG. 3 and FIG. 6, the feeder network 3 may be a differential feeder network, and the feeder network 3 may include a transmission line 192 and a transmission line 190. The transmission line 192 may be directly electrically connected to the open end 1101, and the transmission line 190 may be directly electrically connected to the open end 1102. The transmission line 192 may feed a signal 1 at the open end 1101, and the transmission line 190 may feed a signal 2 at the open end 1102. A difference between a phase of the signal 1 and a phase of the signal 2 may be 180°. Therefore, this helps implement differential feeding of the antenna 10. In a possible case, the open end 1101 and the open end 1102 may be two feeding ports of the antenna 10.

The antenna 10 may further have a ground port, and the antenna 10 may be grounded at the ground port. In some embodiments, the ground port of the antenna 10 may be directly electrically connected to the reflection plate 12, to ground the antenna 10. In some other embodiments, the feeder network 3 may include a ground line, and the ground port of the antenna 10 may be directly electrically connected to the ground line of the feeder network 3, to ground the antenna 10. In other words, a part of the transmission line of the feeder network 3 may be for grounding. The transmission line of the feeder network 3 for grounding may form the ground line of the feeder network 3. In a possible case, the ground line of the feeder network 3 may be directly electrically connected to the ground port of the antenna 10 through a through hole on the reflection plate 12.

To enable the antenna 10 to work in the operating frequency band, an electrical length of the resonator 110 may be similar to or the same as an electrical length of the resonator 120. In some embodiments, the electrical length of the resonator 110 may be (¼ to ¾)λ, for example, 2/2; and the electrical length of the resonator 120 may be (¼ to ¾) λ, for example, λ/2, where λ is the wave length corresponding to the center frequency of the operating frequency band of the antenna. In a possible case, a difference between the electrical length of the resonator 110 and the electrical length of the resonator 120 is less than λ/4.

To enable energy transfer efficiency between the resonator 110 and the resonator 120 to be relatively high, the resonator 110 and the resonator 120 may be as close as possible. In some embodiments, a spacing between the resonator 110 and the resonator 120 is less than λ/5, λ/8, λ/10, or λ/15, where λ is the wave length corresponding to the center frequency of the operating frequency band of the antenna.

In some embodiments shown in FIG. 4, projection is performed in a direction parallel to the plane of symmetry 21 and perpendicular to the reflection plate 12, and a projection region of the resonator 110 may at least partially overlap a projection region of the resonator 120. Therefore, energy can be propagated between the resonator 110 and the resonator 120 in the direction perpendicular to the reflection plate 12 as much as possible. This helps reduce an energy loss between the resonator 110 and the resonator 120.

In an embodiment, projection is performed in the direction parallel to the plane of symmetry 21 and perpendicular to the reflection plate 12, and the projection region of the resonator 110 may be located inside the projection region of the resonator 120. A projection area of the resonator 120 is relatively large. In one aspect, this helps increase energy received by the resonator 120 from the resonator 110. In another aspect, capabilities of the resonator 120 to radiate a signal and receive a signal can be relatively strong. Therefore, this helps improve a gain of the antenna 10.

In some embodiments provided in this application, the resonator 120 may be symmetric relative to a plane of symmetry 22. The resonator 120 has symmetry. This helps improve overall performance of the antenna 10. In some embodiments, the plane of symmetry 22 and the plane of symmetry 21 may be disposed in a cross manner. In some other embodiments, the plane of symmetry 22 and the plane of symmetry 21 may be parallel to each other, and a spacing between the plane of symmetry 22 and the plane of symmetry 21 may be relatively small. In an embodiment, as shown in FIG. 4 to FIG. 6, the plane of symmetry 22 and the plane of symmetry 21 may be coplanar. The entire antenna 10 is symmetric relative to a same plane of symmetry. This helps further improve the overall performance of the antenna 10. For example, this helps improve cross polarization performance of the antenna 10.

An electrical length of each portion of the resonator 110 is designed, so that various performance (for example, feeding performance, radio frequency performance, and coupling strength of each portion) of the resonator 110 can be adjusted. In addition, an electrical length corresponds to a physical length. Therefore, a physical length of each portion of the resonator 110 is designed, so that performance of the antenna 10 can be adjusted.

In the embodiment shown in FIG. 4, adjusting an electrical length of the portion 113 can help adjust coupling strength between the resonator 110 and the resonator 120. There may be a relatively large coupling coefficient between the portion 113 and the resonator 120, and there may be a relatively small coupling coefficient both between the portion 111 and the resonator 120 and between the portion 112 and the resonator 120. If the electrical length of the portion 113 is relatively long, an effective coupling region between the resonator 110 and the resonator 120 is relatively large. This helps improve the energy transfer efficiency between the resonator 110 and the resonator 120.

In the embodiment shown in FIG. 4, when the electrical length of the portion 113 meets a requirement on the coupling strength between the resonator 110 and the resonator 120, adjusting a size of the portion 111 or the portion 112 in the direction perpendicular to the reflection plate 12 can help adjust the bandwidth of the antenna 10. If the portion 111 (or the portion 112) has a relatively large size in the direction perpendicular to the reflection plate 12, it helps enable the antenna 10 to have relatively large bandwidth. If the portion 111 (or the portion 112) has a relatively small size in the direction perpendicular to the reflection plate 12, it helps enable the antenna 10 to have relatively small bandwidth.

When the electrical length of the portion 113 meets the requirement on the coupling strength between the resonator 110 and the resonator 120, adjusting a spacing between the open end 1101 and the plane of symmetry 21 or a spacing between the open end 1102 and the plane of symmetry 21 can also help adjust the bandwidth of the antenna 10.

In the embodiment shown in FIG. 4, both the portion 111 and the portion 112 may be perpendicular to the portion 113. Both the extension direction of the portion 111 and the extension direction of the portion 112 may be parallel to the plane of symmetry 21. The spacing between the open end 1101 and the plane of symmetry 21 may be equal to a spacing between the portion 111 and the plane of symmetry 21. A spacing between the open end 1102 and the plane of symmetry 22 may be equal to a spacing between the portion 112 and the plane of symmetry 22.

In another embodiment, if the spacing between the open end 1101 and the plane of symmetry 21 and the spacing between the open end 1102 and the plane of symmetry 21 are reduced or increased, both the portion 111 and the portion 112 may be oblique to the portion 113. In other words, both the extension direction of the portion 111 and the extension direction of the portion 112 may be oblique to the plane of symmetry 21. In an embodiment, both the portion 111 and the portion 112 may extend from the portion 113 toward the plane of symmetry 21, to reduce the spacing between the open end 1101 and the plane of symmetry 21 and the spacing between the open end 1102 and the plane of symmetry 21. In another embodiment, both the portion 111 and the portion 112 may extend from the portion 113 away from the plane of symmetry 21, to increase the spacing between the open end 1101 and the plane of symmetry 21 and the spacing between the open end 1102 and the plane of symmetry 21.

If the spacing between the open end 1101 (or the open end 1102) and the plane of symmetry 21 is relatively large, it helps enable the antenna 10 to have relatively large bandwidth. If the spacing between the open end 1101 (or the open end 1102) and the plane of symmetry 21 is relatively small, it helps enable the antenna 10 to have relatively small bandwidth. Through the foregoing adjustment, flexible setting of the bandwidth of the antenna 10 is implemented.

To make full use of a reflection function of the reflection plate 12, a spacing between the resonator 120 and the reflection plate 12 should not be excessively large. In some embodiments, the spacing between the resonator 120 and the reflection plate 12 may be less than 0.7λ, where λ is the wave length corresponding to the center frequency of the operating frequency band of the antenna.

A spacing between the resonator 110 and the reflection plate 12 may be flexibly adjusted based on the spacing between the resonator 120 and the reflection plate 12 and a size of the resonator 110 in the direction perpendicular to the reflection plate 12. In some embodiments, the spacing between the resonator 110 and the reflection plate 12 may be less than λ/5, λ/8, λ/10, or λ/15, where λ is the wave length corresponding to the center frequency of the operating frequency band of the antenna.

The following describes a plurality of possible structures of the resonator 110 with reference to FIG. 7 to FIG. 18.

FIG. 7 is a diagram of a structure of an antenna 10 according to an embodiment of this application. The diagram of the structure shown in FIG. 7 may be a front view of the antenna 10.

A difference from the antenna 10 shown in FIG. 4 lies in that, in the antenna 10 shown in FIG. 7, an open end 1101 and an open end 1102 of a resonator 110 may be disposed away from a reflection plate 12 and close to a resonator 120, a portion 113 of the resonator 110 may be disposed close to the reflection plate 12 and away from the resonator 120. The open end 1101 and the open end 1102 of the resonator 110 may be coupled to the resonator 120. Therefore, the coupling between the resonator 110 and the resonator 120 may correspond to electric field coupling. Therefore, this helps flexibly adjust high-frequency rejection performance or low-frequency rejection performance of the antenna 10.

The portion 113 of the resonator 110 may be disposed close to the reflection plate 12, to help the antenna 10 receive feeding.

In some embodiments, as shown in FIG. 7, with reference to FIG. 3 and FIG. 4, a transmission line 190 of a feeder network 3 may directly feed power on the portion 113 of the resonator 110 or be coupled to the portion 113 of the resonator 110 for feeding. In other words, the portion 113 may be configured to receive feeding. A distance between a feeding location on the portion 113 and a plane of symmetry 21 is adjusted, so that bandwidth of the antenna 10 can be adjusted.

In some other embodiments, a transmission line 190 of a feeder network 3 may feed power on a portion 111 or a portion 112 of the resonator 110. This helps further improve bandwidth of the antenna 10.

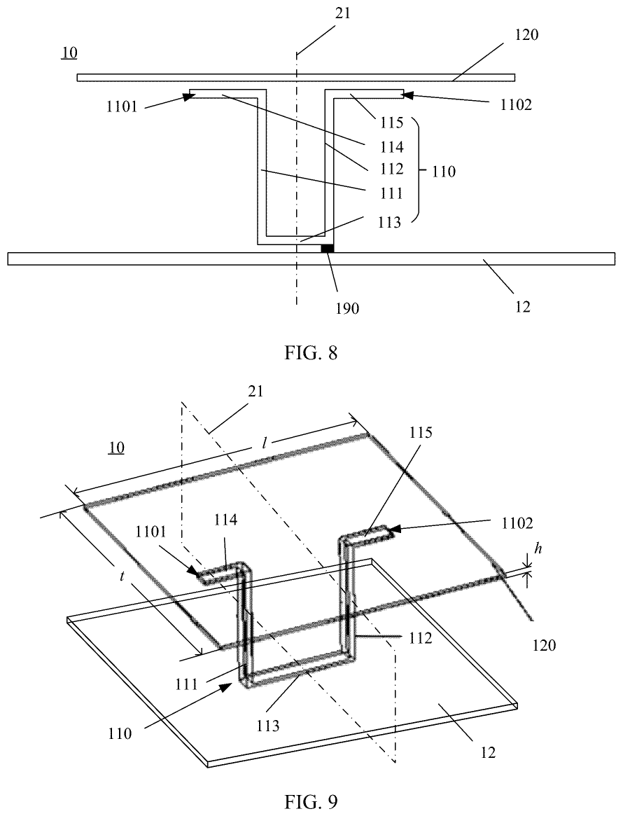

FIG. 8 is a diagram of a structure of an antenna 10 according to an embodiment of this application. The diagram of the structure shown in FIG. 8 may be a front view of the antenna 10. FIG. 9 is a three-dimensional diagram of the antenna 10 according to an embodiment of this application.

A difference from the antenna 10 shown in FIG. 7 lies in that, in the antenna 10 shown in FIG. 8, a resonator 110 may further include a portion 114 and a portion 115. The portion 114 may be mechanically connected to an end of a portion 111 away from a portion 113, and the portion 115 may be mechanically connected to an end of a portion 112 away from the portion 113. The portion 111 may be mechanically connected between the portion 114 and the portion 113. The portion 112 may be mechanically connected between the portion 115 and the portion 113. The portion 114 may be symmetric to the portion 115 relative to a plane of symmetry 21.

An extension direction of the portion 114 may be parallel, oblique, or perpendicular to the plane of symmetry 21. An extension direction of the portion 115 may be parallel, oblique, or perpendicular to the plane of symmetry 21. The extension direction of the portion 114 may be different from an extension direction of the portion 111. The extension direction of the portion 115 may be different from an extension direction of the portion 112. In the embodiments shown in FIG. 8 and FIG. 9, the portion 114 may be perpendicular to the plane of symmetry 21, and the portion 115 may be perpendicular to the plane of symmetry 21. The portion 114 and the portion 115 may be parallel to a resonator 120.

In the embodiment shown in FIG. 8, the portion 114 and the portion 115 may be located on a side that is of the resonator 110 and that is close to the resonator 120. As shown in FIG. 8 and FIG. 9, the resonator 110 may be coupled to the resonator 120 through the portion 114 and the portion 115. An electrical length of the portion 114 and an electrical length of the portion 115 are adjusted, so that coupling strength between the resonator 110 and the resonator 120 can be adjusted. If the electrical length of the portion 114 and the electrical length of the portion 115 are relatively long, an effective coupling region between the resonator 110 and the resonator 120 is relatively large. Therefore, this helps improve the coupling strength between the resonator 110 and the resonator 120.

In the embodiments shown in FIG. 8 and FIG. 9, an end of the portion 114 away from the portion 111 may be an open end 1101 of the resonator 110, and an end of the portion 115 away from the portion 112 may be an open end 1102 of the resonator 110. Therefore, the coupling between the resonator 110 and the resonator 120 may correspond to electric field coupling. Therefore, this helps flexibly adjust high-frequency rejection performance or low-frequency rejection performance of the antenna 10.

In comparison with the embodiments shown in FIG. 4 to FIG. 7, in the embodiment shown in FIG. 8, an electrical length of a portion that is of the resonator 110 and that is coupled to the resonator 120 may be relatively long, and a portion that is of the resonator 110 and that is for feeding may be relatively long. This helps enable the antenna 10 to have a relatively low loss and relatively large bandwidth.

The embodiment shown in FIG. 9 shows a diagram of a structure of the resonator 120 according to an embodiment of this application.

In the embodiment shown in FIG. 9, the resonator 120 may be a plate. A length l of the resonator 120 may correspond to the longest side of the resonator 120, a height h of the resonator 120 may correspond to the shortest side of the resonator 120, and a width/of the resonator 120 may be less than or equal to the length l of the resonator 120 and greater than the height h of the resonator 120. The length l of the resonator 120 may correspond to an electrical length direction of the resonator 120. In some embodiments, the resonator 120 may be of a patch structure. In an embodiment, the width/of the resonator 120 may be equal to the length l of the resonator 120. The length l of the resonator 120 is adjusted, so that an operating frequency band of the antenna 10 can be adjusted. The width t of the resonator 120 is adjusted, so that the coupling strength between the resonator 110 and the resonator 120 can be adjusted, and further, the bandwidth of the antenna 10 can be adjusted.

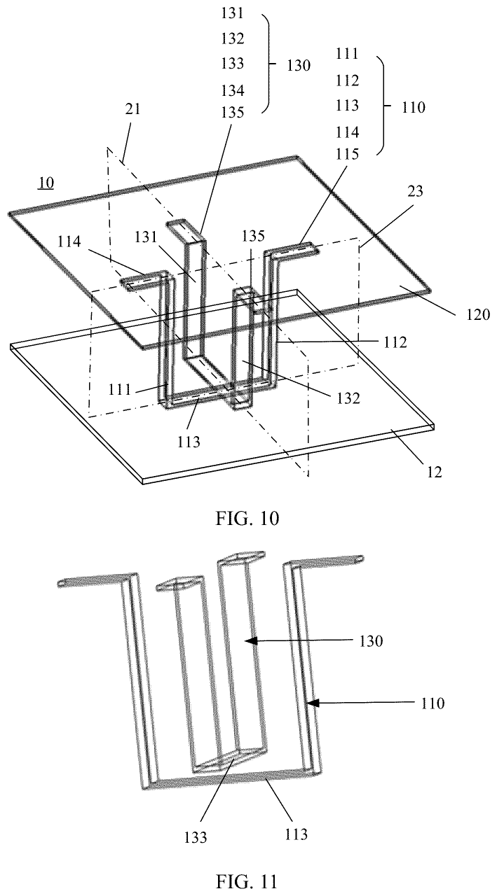

FIG. 10 is a diagram of a structure of an antenna 10 according to an embodiment of this application.

A difference from the antenna 10 shown in FIG. 8 and FIG. 9 lies in that, in the antenna 10 shown in FIG. 10, the antenna 10 may further include a resonator 130. The resonator 130 may be located between a resonator 120 and a reflection plate 12. The resonator 130 may be coupled to the resonator 120. The resonator 130 may include a plurality of portions with different extension directions. The resonator 130 may be symmetric relative to a plane of symmetry 23. The plane of symmetry 23 may be perpendicular to a plane of symmetry 21. The resonator 120 is fed through a resonator 110 and the resonator 130, so that dual polarization of the antenna 10 is implemented. In some embodiments, the resonator 110 may be symmetric relative to the plane of symmetry 23. The resonator 130 may be symmetric relative to the plane of symmetry 21. Therefore, this helps improve overall symmetry of the antenna 10, and helps improve overall radio frequency performance of the antenna 10.

As shown in FIG. 10, the resonator 130 may include a portion 131, a portion 132, a portion 133, a portion 134, and a portion 135. The portion 131 may be symmetric to the portion 132 relative to the plane of symmetry 23. The portion 133 may be directly mechanically connected between the portion 131 and the portion 132. The portion 133 may be symmetric relative to the plane of symmetry 23. The portion 134 may be mechanically connected to an end of the portion 131 away from the portion 133. The portion 135 may be mechanically connected to an end of the portion 132 away from the portion 133. The portion 131 may be mechanically connected between the portion 134 and the portion 133. The portion 132 may be mechanically connected between the portion 135 and the portion 133. The portion 134 may be symmetric to the portion 135 relative to the plane of symmetry 23. The portion 133 may be disposed close to the reflection plate 12 and away from the resonator 120. The portion 134 and the portion 135 may be disposed away from the reflection plate 12 and close to the resonator 120.

In an embodiment, a portion 114 and a portion 115 of the resonator 110 and the portion 134 and the portion 135 of the resonator 130 may be disposed on a same plane close to the resonator 120, so that coupling strength between the resonator 110 and the resonator 120 can be as consistent as possible with coupling strength between the resonator 130 and the resonator 120.

FIG. 11 is a diagram of a structure of the resonator 110 and the resonator 130 according to an embodiment of this application. The resonator 110 and the resonator 130 may be disposed at intervals. Therefore, this helps achieve relatively good isolation between the resonator 110 and the resonator 130. A portion 113 of the resonator 110 may be located on a side of the resonator 110 away from the resonator 120. The portion 133 of the resonator 130 may be located on the side of the resonator 130 away from the resonator 120. The portion 113 and the portion 133 are close to each other. A spacing distance between the portion 113 and the portion 133 is adjusted, so that dual polarization performance of the antenna 10 can be optimized.

The antenna 10 shown in FIG. 10 may have a plurality of feeding manners.

In some embodiments, with reference to FIG. 3 and FIG. 10, a feeder network 3 may directly feed power on the resonator 110 or the resonator 130, or be coupled to the resonator 110 or the resonator 130 for feeding. For specific implementations of the direct feeding and the coupled feeding, respectively refer to the embodiments shown in FIG. 4 and FIG. 5. In a possible case, the feeder network 3 may feed power on the portion 113 of the resonator 110 or the portion 133 of the resonator 130. In an embodiment, the feeder network 3 may be coupled to the resonator 110 for feeding, and the feeder network 3 may feed the resonator 130 by using a coupling relationship between the resonator 110 and the resonator 130. In another embodiment, the feeder network 3 may be coupled to the resonator 130 for feeding, and the feeder network 3 may feed the resonator 110 by using a coupling relationship between the resonator 110 and the resonator 130.

In some other embodiments, with reference to FIG. 3 and FIG. 10, a feeder network 3 may differentially feed power on the resonator 110 or the resonator 130. In other words, the feeder network 3 may feed power at two different locations on a same resonator. When the feeder network 3 feeds power on the resonator 110, the feeder network 3 may differentially feed the resonator 130 by using a coupling relationship between the resonator 110 and the resonator 130. When the feeder network 3 feeds power on the resonator 130, the feeder network 3 may differentially feed the resonator 110 by using a coupling relationship between the resonator 110 and the resonator 130. Therefore, this helps implement differential feeding of the dual-polarized antenna 10. In a possible case, the feeder network 3 may differentially feed power on the portion 113 of the resonator 110 or the portion 133 of the resonator 130.

In still some embodiments, the feeder network 3 may separately feed power on the resonator 110 and the resonator 130. A specific feeding manner of the feeder network 3 may be direct feeding or coupled feeding.

In yet some embodiments, the feeder network 3 may separately differentially feed power on the resonator 110 and the resonator 130. In other words, the feeder network 3 may feed power at two different locations on the resonator 110 and at two different locations on the resonator 130. Therefore, this helps implement differential feeding of the dual-polarized antenna 10.

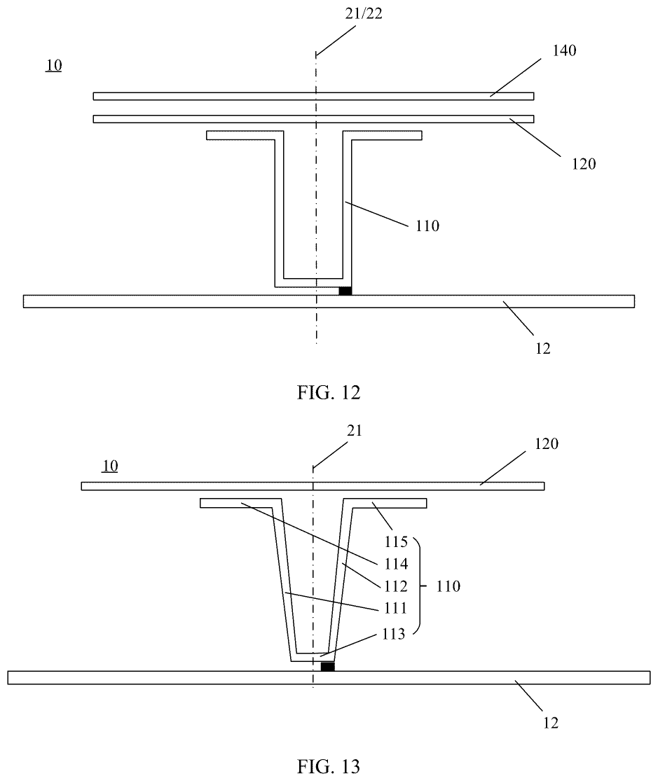

FIG. 12 is a diagram of a structure of an antenna 10 according to an embodiment of this application. The diagram of the structure shown in FIG. 12 may be a front view of the antenna 10.

A difference from the antenna 10 shown in FIG. 8 lies in that, in the antenna 10 shown in FIG. 12, the antenna 10 may further include a resonator 140. The resonator 140 may be located on a side of a resonator 120 away from a reflection plate 12. The resonator 140 may be coupled to the resonator 120. In some embodiments, the resonator 140 is symmetric relative to a plane of symmetry 22. In other words, the resonator 140 and the resonator 120 may be symmetric relative to the same plane of symmetry.

The resonator 140 may serve as a radiating element of the antenna 10 together with the resonator 120. Therefore, this helps improve a gain of the antenna 10. In this embodiment provided in this application, the antenna 10 may further include more resonators serving as radiating elements.

To enable the antenna 10 to work in an operating frequency band, an electrical length of the resonator 140 may be similar to or the same as an electrical length of the resonator 120. In some embodiments, the electrical length of the resonator 140 may be (¼ to ¾)λ, for example, ½, where λ is a wave length corresponding to a center frequency of the operating frequency band of the antenna. In a possible case, a difference between the electrical length of the resonator 140 and the electrical length of the resonator 120 may be less than λ/4.

FIG. 13 to FIG. 15 are diagrams of structures of three antennas 10 according to embodiments of this application. The diagrams of the structures shown in FIG. 13 to FIG. 15 may be front views of the antennas 10.

A difference from the antenna 10 shown in FIG. 8 lies in that, in the antennas 10 shown in FIG. 13 to FIG. 15, both a portion 111 and a portion 112 may be oblique to a portion 113. In other words, both an extension direction of the portion 111 and an extension direction of the portion 112 may be oblique to a plane of symmetry 21.

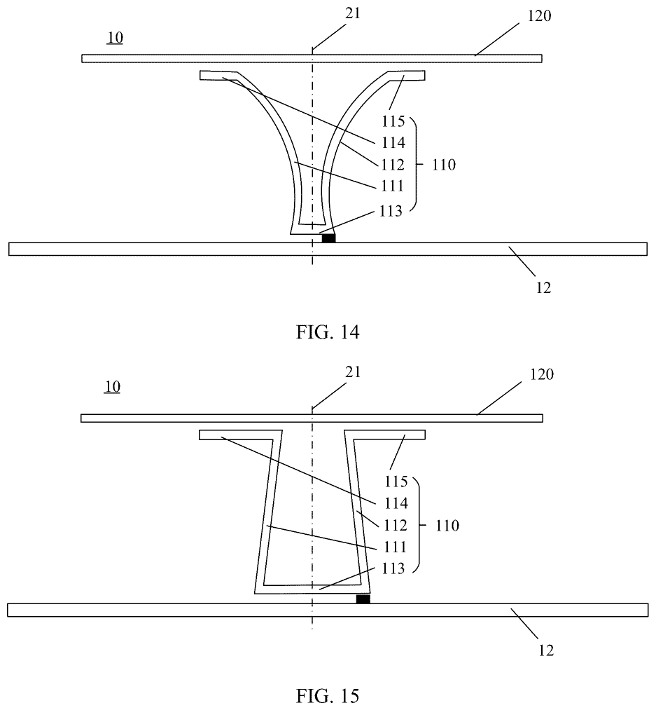

In an example shown in FIG. 13 and FIG. 14, both a portion 111 and a portion 112 may extend from a portion 113 away from a plane of symmetry 21. Therefore, this helps enable an electrical length of the portion 113 to be relatively short, helps increase electrical lengths of a portion 114 and a portion 115, and further, helps improve a filtering effect of an antenna 10. In addition, a spacing between a feeding location of a feeder network 3 on the portion 113 and the plane of symmetry 21 may be relatively small. This helps implement narrowband filtering. As shown in FIG. 13, a portion 111 and a portion 112 may be in a straight line shape. As shown in FIG. 14, a portion 111 and a portion 112 may be in an arc shape.

In an example shown in FIG. 15, both a portion 111 and a portion 112 may extend from a portion 113 close to a plane of symmetry 21. Therefore, this enables an electrical length of the portion 113 to be relatively long, helps enable an antenna 10 to have relatively wide bandwidth, helps control coupling strength, and optimizes filtering performance. In addition, electrical lengths of a portion 114 and a portion 115 may be relatively long. This helps improve bandwidth of the antenna 10. As shown in FIG. 15, the portion 111 and the portion 112 may be in a straight line shape. In another embodiment, the portion 111 and the portion 112 may be in an arc shape.

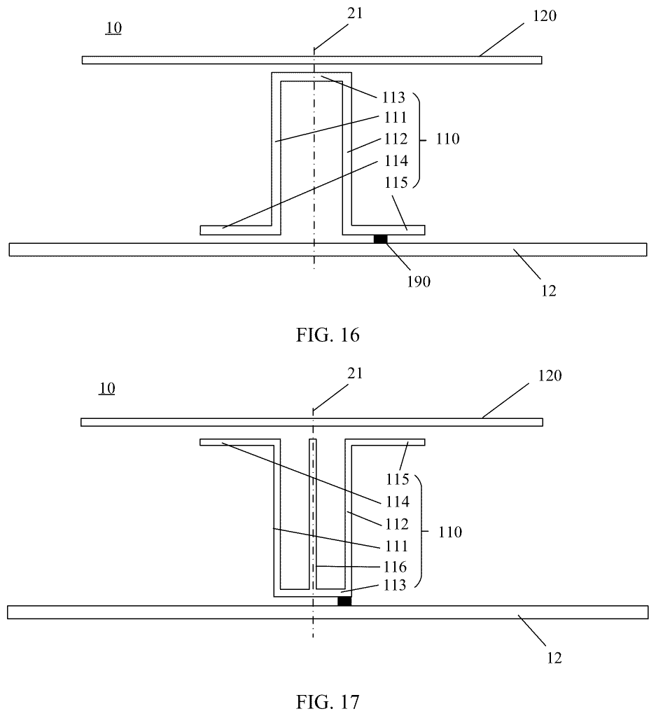

FIG. 16 is a diagram of a structure of an antenna 10 according to an embodiment of this application. The diagram of the structure shown in FIG. 16 may be a front view of the antenna 10.

A difference from the antenna 10 shown in FIG. 8 lies in that, in the antenna 10 shown in FIG. 16, a portion 114 and a portion 115 may be disposed close to a reflection plate 12 and away from a resonator 120. A portion 113 may be disposed away from the reflection plate 12 and close to the resonator 120. A resonator 110 may be coupled to the resonator 120 through the portion 113. Adjusting an electrical length of the portion 113 can help adjust coupling strength between the resonator 110 and the resonator 120. The coupling between the resonator 110 and the resonator 120 may correspond to magnetic field coupling. Therefore, this helps flexibly adjust high-frequency rejection performance or low-frequency rejection performance of the antenna 10.

The portion 114 and the portion 115 of the resonator 110 may be disposed close to the reflection plate 12, to help the antenna 10 receive feeding. In some embodiments, with reference to FIG. 3 and FIG. 16, a feeder network 3 may feed power on the portion 115, to help the antenna 10 receive a feeding signal. In other words, the portion 115 may be configured to receive feeding. A transmission line 190 of the feeder network 3 may directly feed power on the portion 115 or be coupled to the portion 115 for feeding. A distance between a feeding location on the portion 115 and a plane of symmetry 21 is adjusted, so that bandwidth of the antenna 10 can be adjusted.

In the embodiment shown in FIG. 16, a portion 111 may be perpendicular to the portion 113. An extension direction of the portion 111 may be parallel to the plane of symmetry 21.

A distance between an end of the portion 115 close to the portion 111 and the plane of symmetry 21 is the shortest. The feeding location on the portion 115 is disposed at the end of the portion 115 close to the portion 111. This helps implement relatively narrow bandwidth. If the extension direction of the portion 111 is oblique to the plane of symmetry 21, and the portion 111 extends from the portion 113 toward the plane of symmetry 21, the distance between the end of the portion 115 close to the portion 111 and the plane of symmetry 21 may be shortened. This helps implement narrower bandwidth.

A distance between an end of the portion 115 away from the portion 111 and the plane of symmetry 21 is the longest. The feeding location on the portion 115 is disposed at the end of the portion 115 away from the portion 111. This helps implement relatively wide bandwidth. If the extension direction of the portion 111 is oblique to the plane of symmetry 21, and the portion 111 extends from the portion 113 away from the plane of symmetry 21, the distance between the end of the portion 115 away from the portion 111 and the plane of symmetry 21 may be lengthened. This helps implement wider bandwidth.

In this embodiment provided in this application, the antenna 10 shown in FIG. 16 may further have another feeding manner. For the another feeding manner of the antenna 10 shown in FIG. 16, refer to the coupled feeding manner and the differential feeding manner in the embodiments shown in FIG. 5 and FIG. 6.

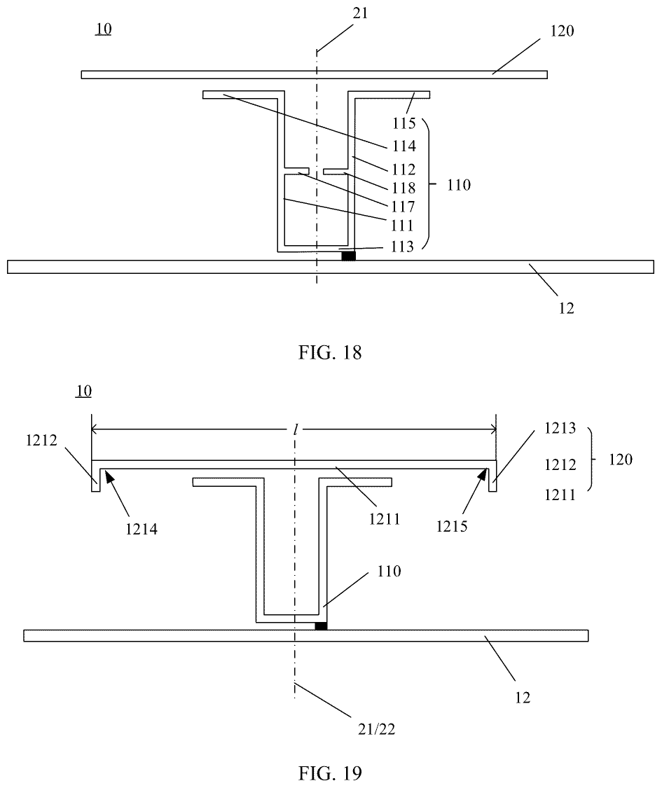

FIG. 17 and FIG. 18 are diagrams of structures of two antennas 10 according to embodiments of this application. The diagrams of the structures shown in FIG. 17 and FIG. 18 may be front views of the antennas 10.

In comparison with the embodiment shown in FIG. 8, in an antenna 10 shown in FIG. 17, a resonator 110 may further include a portion 116, and the portion 116 may be symmetric relative to a plane of symmetry 21. An end of the portion 116 may be mechanically connected to a portion 113, and the portion 116 may extend from the portion 113 toward a resonator 120.

In comparison with the embodiment shown in FIG. 8, in an antenna 10 shown in FIG. 18, a resonator 110 may further include a portion 117 and a portion 118, and the portion 117 may be symmetric to the portion 118 relative to a plane of symmetry 21. An end of the portion 117 may be mechanically connected to a portion 111. An end of the portion 118 may be mechanically connected to a portion 112.

In an embodiment, the portion 117 may extend from the portion 111 toward the portion 112. The portion 118 may extend from the portion 112 toward the portion 111. As shown in FIG. 18, the portion 117 may be perpendicular to the portion 111. The portion 117 may be parallel to a portion 114 and a portion 113. The portion 118 may be perpendicular to the portion 112. The portion 118 may be parallel to a portion 115 and the portion 113.

In another embodiment, the portion 117 may extend from the portion 111 away from the portion 112. The portion 118 may extend from the portion 112 away from the portion 111.

FIG. 4 to FIG. 18 are diagrams of a plurality of structures of a resonator 110 according to embodiments of this application. Further, FIG. 19 to FIG. 27 are diagrams of structures of a resonator 120 according to embodiments of this application. The following describes a plurality of other possible structures of the resonator 120 with reference to FIG. 19 to FIG. 27. In embodiments provided in this application, the resonator 110 in the antenna 10 may be any one shown in FIG. 4 to FIG. 18, and the resonator 120 in the antenna 10 may be any one shown in FIG. 4 and FIG. 19 to FIG. 27. In the embodiments in FIG. 19 to FIG. 27, a structure of a resonator 110 is the same as or similar to a structure of the resonator 110 shown in FIG. 8. However, it may be understood that the resonator 110 in FIG. 19 to FIG. 27 may be replaced with the resonator 110 in FIG. 4 to FIG. 18.

FIG. 19 is a diagram of a structure of an antenna 10 according to an embodiment of this application. The diagram of the structure shown in FIG. 19 may be a front view of the antenna 10.

A difference from the embodiments shown in FIG. 8 and FIG. 9 lies in that, in the antenna 10 shown in FIG. 19, a central region of a resonator 120 may be a plate, and an edge region of the resonator 120 may have a protrusion. An edge of the plate is processed to form the protrusion. Therefore, this helps reduce a size of the resonator 120 in a direction of a length l and/or a direction of a width 1, and helps reduce overall space occupied by the antenna 10.

In the embodiment shown in FIG. 19, the resonator 120 includes a plate 1211, a plate 1212, and a plate 1213, the plate 1211 is symmetric relative to a plane of symmetry 22, the plate 1211 has a plate end portion 1214 and a plate end portion 1215, the plate 1212 is disposed in a region of the plate 1211 close to the plate end portion 1214, the plate 1213 is disposed in a region of the plate 1211 close to the plate end portion 1215, and the plate 1212 is symmetric to the plate 1213 relative to the plane of symmetry 22. Both the plate 1212 and the plate 1213 may extend from the plate 1211 toward or away from a reflection plate 12. In some embodiments, both the plate 1212 and the plate 1213 may be perpendicular to the plate 1211. In some other embodiments, both the plate 1212 and the plate 1213 may be oblique to the plate 1211.

In the embodiment shown in FIG. 19, the plate 1212 and the plate 1213 are disposed on two sides of the plate 1211 in the direction of the length l of the plate 1211. In another possible scenario, the plate 1212 and the plate 1213 are disposed on two sides of the plate 1211 in the direction of the width/of the plate 1211.

In some embodiments provided in this application, the resonator 120 shown in FIG. 19 may be obtained by performing processes such as soldering, bending, and deep drawing on an edge of a raw plate material.

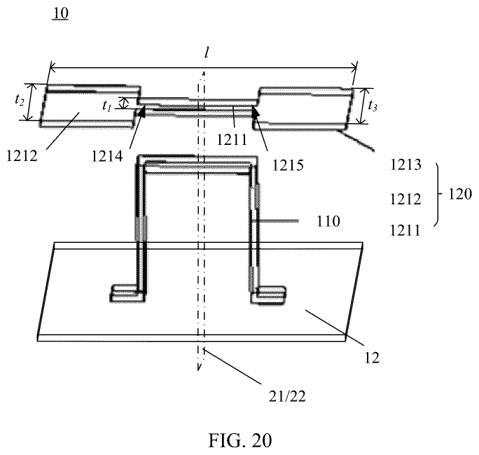

FIG. 20 is a diagram of a structure of an antenna 10 according to an embodiment of this application. The diagram of the structure shown in FIG. 20 may be a three-dimensional diagram of the antenna 10.

A difference from the embodiment shown in FIG. 19 lies in that, in the antenna 10 shown in FIG. 20, a plate 1211, a plate 1212, and a plate 1213 are coplanar. A width t₁ of the plate 1211 is different from a width 12 of the plate 1212. The width t₁ of the plate 1211 is different from a width 13 of the plate 1213.

Widths of a resonator 120 at different locations are changed. This helps adjust a physical length l of the resonator 120 when an electrical length of the resonator 120 remains unchanged.

As shown in FIG. 20, both the width 12 of the plate 1212 and the width 13 of the plate 1213 may be greater than the width t₁ of the plate 1211. The resonator 120 has a relatively large width at a location close to an open end, and the resonator 120 has a relatively small width at a central location. Therefore, this helps reduce the physical length l of the resonator 120 when the electrical length of the resonator 120 remains unchanged, and helps reduce space occupied by the resonator 120 and the antenna 10 in a direction of the length l.

In another embodiment provided in this application, both the width t₂ of the plate 1212 and the width 13 of the plate 1213 may be less than the width t₁ of the plate 1211, so that when the electrical length of the resonator 120 remains unchanged, the physical length l of the resonator 120 is increased. Because the resonator 120 has a relatively large width at a central location, coupling strength between the resonator 120 and a central portion of a resonator 110 can be relatively strong.

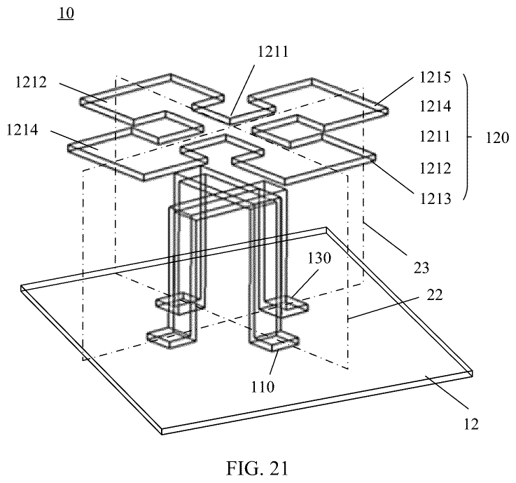

FIG. 21 is a diagram of a structure of an antenna 10 according to an embodiment of this application. The diagram of the structure shown in FIG. 21 may be a three-dimensional diagram of the antenna 10.

A difference from the embodiment shown in FIG. 20 lies in that a resonator 120 shown in FIG. 21 is further symmetric relative to a plane of symmetry 23. A plate 1211 is symmetric relative to a plane of symmetry 22 and the plane of symmetry 23. The resonator 120 may further include a plate 1214 and a plate 1215. The plate 1214 and the plate 1215 are symmetric relative to the plane of symmetry 23.

A difference from the embodiment shown in FIG. 20 lies in that the antenna 10 shown in FIG. 21 may further include a resonator 130. The resonator 130 may be located between the resonator 120 and a reflection plate 12. The resonator 130 and a resonator 110 may feed the resonator 120, so that dual polarization of the antenna 10 is implemented. A projection region of the resonator 110 on the resonator 120 may at least partially overlap the plate 1211, a plate 1212, and a plate 1213. A projection region of the resonator 130 on the resonator 120 may at least partially overlap the plate 1211, the plate 1214, and the plate 1215. For specific descriptions of the resonator 130, refer to the embodiments shown in FIG. 10 and FIG. 11.

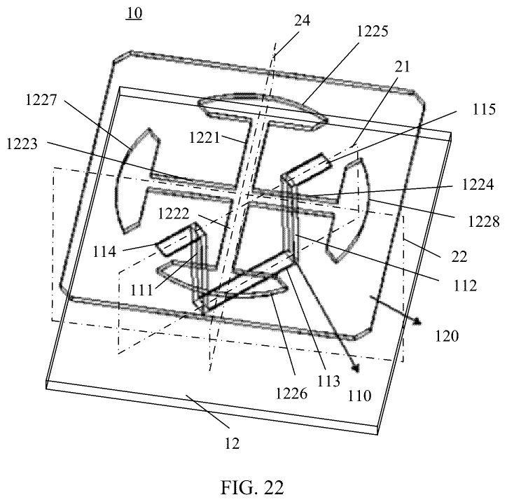

FIG. 22 is a diagram of a structure of an antenna 10 according to an embodiment of this application. The diagram of the structure shown in FIG. 22 may be a three-dimensional diagram of the antenna 10.

A difference from the embodiments shown in FIG. 8 and FIG. 9 lies in that a resonator 120 may have a slot 1221, a slot 1222, a slot 1223, and a slot 1224. The slot 1221 may be symmetric to the slot 1222 relative to a plane of symmetry 22. Both the slot 1223 and the slot 1224 may be disposed on the plane of symmetry 22, and both the slot 1223 and the slot 1224 may be symmetric relative to the plane of symmetry 22. In other words, both the slot 1221 and the slot 1222 may be disposed on a plane of symmetry 24, and both the slot 1221 and the slot 1222 may be symmetric relative to the plane of symmetry 24. The slot 1223 may be symmetric to the slot 1224 relative to the plane of symmetry 24. The plane of symmetry 24 may be perpendicular to the plane of symmetry 22. The slot 1221, the slot 1222, the slot 1223, and the slot 1224 may be in communication with each other at an intersection of the plane of symmetry 22 and the plane of symmetry 24.

The resonator 120 is provided with a plurality of slots. This helps reduce a physical length of the resonator 120 when an electrical length of the resonator 120 remains unchanged. A longer slot of the resonator 120 indicates a smaller physical length of the resonator 120. Therefore, this helps reduce space occupied by the resonator 120.

In some embodiments, as shown in FIG. 22, the resonator 120 further has an opening 1225, an opening 1226, an opening 1227, and an opening 1228. The opening 1225 may be symmetric to the opening 1226 relative to the plane of symmetry 22. The opening 1227 may be symmetric to the opening 1228 relative to the plane of symmetry 24. In other words, both the opening 1225 and the opening 1226 are symmetric relative to the plane of symmetry 24, and both the opening 1227 and the opening 1228 may be symmetric relative to the plane of symmetry 22.

In the embodiment shown in FIG. 22, the opening 1225 may be located on a side of the slot 1221 away from the slot 1222, and is in communication with the slot 1221. The opening 1226 may be located on a side of the slot 1222 away from the slot 1221, and is in communication with the slot 1222. The opening 1227 may be located on a side of the slot 1223 away from the slot 1224, and is in communication with the slot 1223. The opening 1228 may be located on a side of the slot 1224 away from the slot 1223, and is in communication with the slot 1224. In some embodiments, the opening 1225 may be perpendicular to the slot 1221, the opening 1226 may be perpendicular to the slot 1222, the opening 1227 may be perpendicular to the slot 1223, and the opening 1228 may be perpendicular to the slot 1223. The resonator 120 is further provided with the opening, and a distance between the opening and the plane of symmetry of the resonator 120 is relatively long. Therefore, this helps reduce a physical length while ensuring coupling strength between the resonator 120 and a resonator 110.

In the embodiment shown in FIG. 22, a portion 114 and a portion 115 of the resonator 110 may be disposed close to the resonator 120. To enable the coupling strength between the resonator 110 and the resonator 120 to meet a requirement, projection is performed in a direction parallel to a plane of symmetry 21 and perpendicular to a reflection plate 12, and projection regions of the portion 114 and the portion 115 may be located inside a projection region of the resonator 120. In other words, projection regions of the portion 114 and the portion 115 on the resonator 120 may be located outside the slot 1221, the slot 1222, the slot 1223, the slot 1224, the opening 1225, the opening 1226, the opening 1227, and the opening 1228. The plane of symmetry 21 and the plane of symmetry 22 may be disposed in a cross manner, and the plane of symmetry 21 and the plane of symmetry 24 may be disposed in a cross manner.

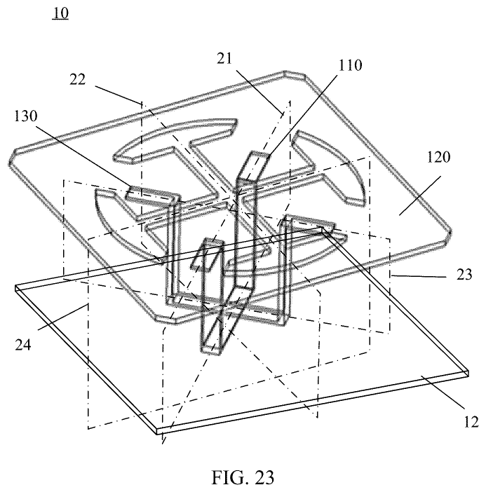

FIG. 23 is a diagram of a structure of an antenna 10 according to an embodiment of this application. The diagram of the structure shown in FIG. 23 may be a three-dimensional diagram of the antenna 10.

A difference from the embodiment shown in FIG. 22 lies in that the antenna 10 shown in FIG. 23 may further include a resonator 130. The resonator 130 may be located between a resonator 120 and a reflection plate 12. The resonator 130 may be symmetric relative to a plane of symmetry 23. The resonator 130 and a resonator 110 may feed the resonator 120, so that dual polarization of the antenna 10 is implemented. Projection is performed in a direction parallel to a plane of symmetry 21 and perpendicular to the reflection plate 12, and a projection region of a portion that is of the resonator 130 and that is disposed close to the resonator 120 may be located inside a projection region of the resonator 120. In other words, a projection region of the portion that is of the resonator 130 and that is disposed close to the resonator 120 on the resonator 120 may be located outside slots and openings of the resonator 120. The resonator 130 may be symmetric relative to the plane of symmetry 23. The plane of symmetry 23 and a plane of symmetry 22 may be disposed in a cross manner, and the plane of symmetry 23 and a plane of symmetry 24 may be disposed in a cross manner. For specific descriptions of the resonator 130, refer to the embodiments shown in FIG. 10 and FIG. 11.

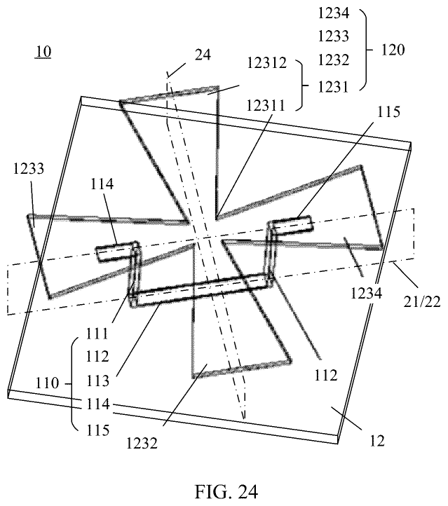

FIG. 24 is a diagram of a structure of an antenna 10 according to an embodiment of this application. The diagram of the structure shown in FIG. 24 may be a three-dimensional diagram of the antenna 10.

A difference from the embodiments shown in FIG. 8 and FIG. 9 lies in that a resonator 120 may include an extension portion 1231 and an extension portion 1232. The extension portion 1231 is symmetric to the extension portion 1232 relative to a plane of symmetry 22. The extension portion 1231 and the extension portion 1232 may be connected at the plane of symmetry 22.

In some embodiments, the extension portion 1231 may have an extension portion end 12311 and an extension portion end 12312. The extension portion end 12311 is an end of the extension portion 1231 close to the extension portion 1232, and the extension portion end 12312 is an end of the extension portion 1231 away from the extension portion 1232. From the extension portion end 12311 to the extension portion end 12312, a width of the extension portion 1231 may gradually increase. Because the extension portion 1232 is symmetric to the extension portion 1231, a width of the extension portion 1232 may gradually increase from an end of the extension portion 1232 close to the extension portion 1231 to an end of the extension portion 1232 away from the extension portion 1231. Therefore, the resonator 120 may have a relatively small width at a central location. This helps reduce a physical length of the resonator 120 when an electrical length of the resonator 120 remains unchanged, and helps reduce space occupied by the resonator 120 and the antenna 10 in a length direction.

In the embodiment shown in FIG. 24, a portion 114 and a portion 115 of a resonator 110 may be disposed close to the resonator 120. To enable coupling strength between the resonator 110 and the resonator 120 to meet a requirement, projection regions of the portion 114 and the portion 115 on the resonator 120 may be respectively located on the extension portion 1231 and the extension portion 1232.

In some other embodiments, from the extension portion end 12311 to the extension portion end 12312, a width of the extension portion 1231 may gradually reduce. Because the extension portion 1232 is symmetric to the extension portion 1231, a width of the extension portion 1232 may gradually reduce from an end of the extension portion 1232 close to the extension portion 1231 to an end of the extension portion 1232 away from the extension portion 1231. Therefore, the resonator 120 has a relatively large width at a central location. This helps enable that coupling strength between the resonator 120 and a central portion of a resonator 110 can be relatively strong.

In the embodiment shown in FIG. 24, the resonator 120 may further include an extension portion 1233 and an extension portion 1234. Both the extension portion 1233 and the extension portion 1234 are symmetric relative to the plane of symmetry 22. In other words, both the extension portion 1231 and the extension portion 1232 may be symmetric relative to a plane of symmetry 24, the extension portion 1233 may be symmetric to the extension portion 1234 relative to the plane of symmetry 24, and the plane of symmetry 24 may be perpendicular to the plane of symmetry 22. The extension portion 1231, the extension portion 1232, the extension portion 1233, and the extension portion 1234 may be connected at an intersection of the plane of symmetry 22 and the plane of symmetry 24. For structures of the extension portion 1233 and the extension portion 1234, refer to the structures of the extension portion 1231 and the extension portion 1232. When the resonator 120 further includes the extension portion 1233 and the extension portion 1234, in one aspect, the resonator 120 may be symmetric relative to a plurality of planes of symmetry, to improve overall performance of the antenna 10, and in another aspect, this facilitates modification of the antenna 10 from a single-polarized antenna to a dual-polarized antenna.

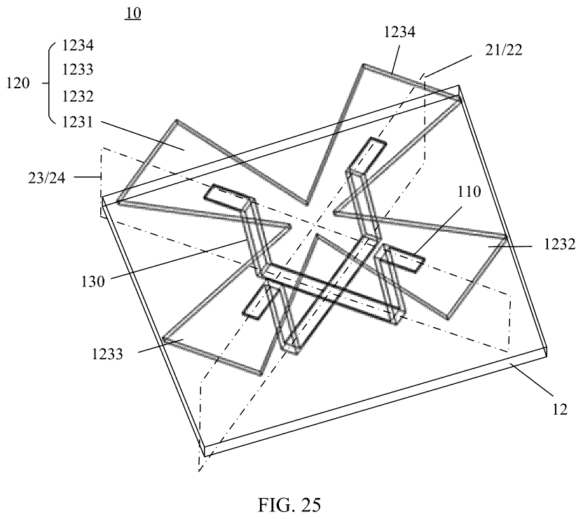

FIG. 25 is a diagram of a structure of an antenna 10 according to an embodiment of this application. The diagram of the structure shown in FIG. 25 may be a three-dimensional diagram of the antenna 10.

A difference from the embodiment shown in FIG. 24 lies in that the antenna 10 shown in FIG. 25 may further include a resonator 130. The resonator 130 may be located between a resonator 120 and a reflection plate 12. The resonator 130 and a resonator 110 may feed the resonator 120, so that dual polarization of the antenna 10 is implemented. A projection region of a portion that is of the resonator 130 and that is disposed close to the resonator 120 on the resonator 120 may be located on an extension portion 1233 and an extension portion 1234. For specific descriptions of the resonator 130, refer to the embodiment shown in FIG. 10.

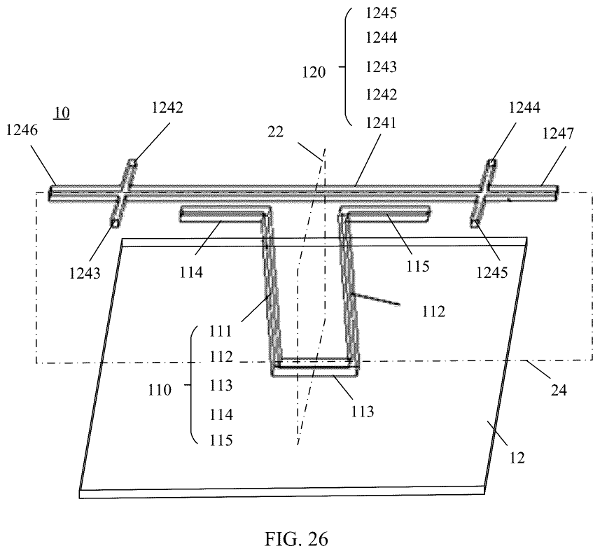

FIG. 26 is a diagram of a structure of an antenna 10 according to an embodiment of this application. The diagram of the structure shown in FIG. 26 may be a three-dimensional diagram of the antenna 10.

A difference from the embodiments shown in FIG. 8 and FIG. 9 lies in that a resonator 120 may include a plate substrate 1241, a parasitic stub 1242, a parasitic stub 1243, a parasitic stub 1244, and a parasitic stub 1245. A portion 114 and a portion 115 of a resonator 110 may be disposed close to the plate substrate 1241. In a direction parallel to a plane of symmetry 21 and perpendicular to a reflection plate 12, projection regions of the portion 114 and the portion 115 may at least partially overlap a projection region of the plate substrate 1241.

The plate substrate 1241 may be symmetric relative to both a plane of symmetry 22 and a plane of symmetry 24. The plate substrate 1241 has an open end 1246 and an open end 1247. The parasitic stub 1242 and the parasitic stub 1243 may be disposed close to the open end 1246, and the parasitic stub 1244 and the parasitic stub 1245 may be disposed close to the open end 1247. The parasitic stub 1242 may be symmetric to the parasitic stub 1243 relative to the plane of symmetry 24. The parasitic stub 1244 may be symmetric to the parasitic stub 1245 relative to the plane of symmetry 24. The parasitic stub 1242 may be symmetric to the parasitic stub 1244 relative to the plane of symmetry 22. The parasitic stub 1243 may be symmetric to the parasitic stub 1245 relative to the plane of symmetry 22. The resonator 120 has parasitic stubs. This helps improve cross polarization performance of the antenna 10. The resonator 120 has relatively high symmetry. This helps improve overall performance of the resonator 120.

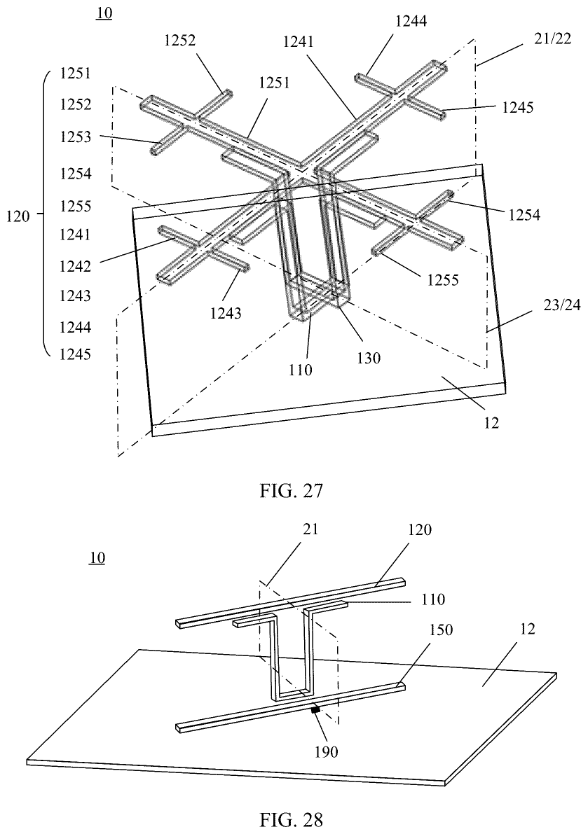

FIG. 27 is a diagram of a structure of an antenna 10 according to an embodiment of this application. The diagram of the structure shown in FIG. 27 may be a three-dimensional diagram of the antenna 10.

A difference from the embodiment shown in FIG. 26 lies in that, in the antenna 10 shown in FIG. 27, a resonator 120 may further include a plate substrate 1251, a parasitic stub 1252, a parasitic stub 1253, a parasitic stub 1254, and a parasitic stub 1255. The plate substrate 1251 may be symmetric relative to both a plane of symmetry 22 and a plane of symmetry 24. The plate substrate 1241 and the plate substrate 1251 may be perpendicularly disposed in a cross manner. The plate substrate 1251 has an open end 1256 and an open end 1257. The parasitic stub 1252 and the parasitic stub 1253 may be disposed close to the open end 1256, and the parasitic stub 1254 and the parasitic stub 1255 may be disposed close to the open end 1257. The parasitic stub 1252 may be symmetric to the parasitic stub 1253 relative to the plane of symmetry 22. The parasitic stub 1254 may be symmetric to the parasitic stub 1255 relative to the plane of symmetry 22. The parasitic stub 1252 may be symmetric to the parasitic stub 1254 relative to the plane of symmetry 24. The parasitic stub 1253 may be symmetric to the parasitic stub 1255 relative to the plane of symmetry 24. The resonator 120 has a plurality of parasitic stubs. This helps increase bandwidth of the antenna 10. The resonator 120 has relatively high symmetry. This helps improve overall performance of the resonator 120.

The antenna 10 may further include a resonator 130. The resonator 130 may be located between the resonator 120 and a reflection plate 12. The resonator 130 and a resonator 110 may feed the resonator 120, so that dual polarization of the antenna 10 is implemented. A projection region of a portion that is of the resonator 130 and that is disposed close to the resonator 120 on the resonator 120 may be located on the plate substrate 1251. For specific descriptions of the resonator 130, refer to the embodiment shown in FIG. 10.

FIG. 28 is a diagram of a structure of an antenna 10 according to an embodiment of this application. The diagram of the structure shown in FIG. 28 may be a three-dimensional diagram of the antenna 10.

A difference from the antenna 10 shown in FIG. 8 lies in that, in the antenna 10 shown in FIG. 28, the antenna 10 may further include a resonator 150. The resonator 150 may be located on a side of a resonator 110 away from a resonator 120. The resonator 150 may be located between the resonator 110 and a reflection plate 12. The resonator 150 may be coupled to the resonator 110. The resonator 150 and the resonator 110 are symmetric relative to a same plane of symmetry. In other words, the resonator 150 may be symmetric relative to a plane of symmetry 21. In the antenna 10, a plurality of resonators are disposed between the reflection plate 12 and the resonator 120 that serves as a radiating element. This helps improve filtering performance of the antenna 10.

In some embodiments, with reference to FIG. 3 and FIG. 28, a transmission line 190 of a feeder network 3 may feed power on the resonator 150. For a specific feeding manner of the antenna 10, refer to the direct feeding manner, the coupled feeding, and the differential feeding shown in FIG. 4 to FIG. 6.

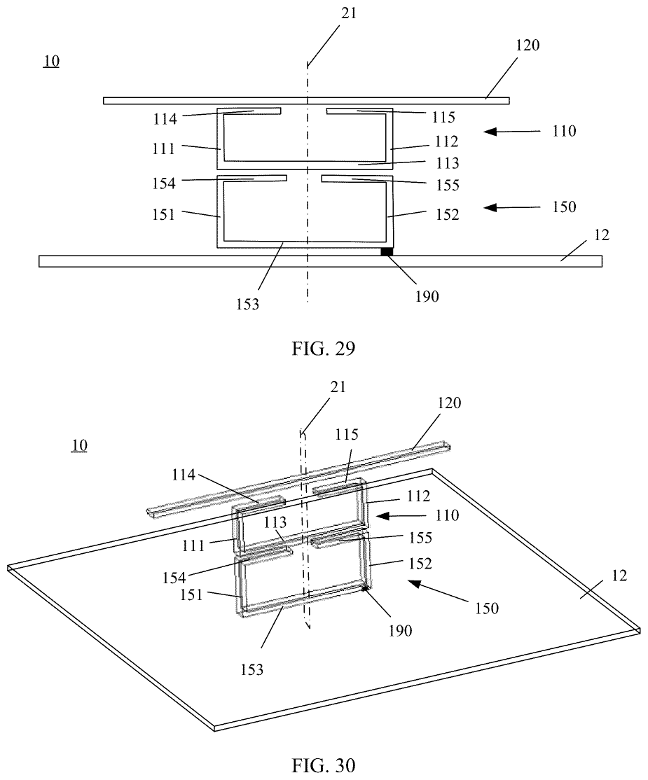

FIG. 29 is a diagram of a structure of an antenna 10 according to an embodiment of this application. The diagram of the structure shown in FIG. 29 may be a front view of the antenna 10. FIG. 30 is a three-dimensional diagram of the antenna 10 shown in FIG. 29.

A difference from the embodiment shown in FIG. 28 lies in that, in the embodiments shown in FIG. 29 and FIG. 30, a portion 114 may extend from a portion 111 toward a portion 112. In other words, the portion 114 may extend from the portion 111 toward a plane of symmetry 21. A portion 115 may extend from the portion 112 toward the portion 111. In other words, the portion 115 may extend from the portion 112 toward the plane of symmetry 21. Therefore, this helps enable coupling between a resonator 110 and a resonator 120 to be electric field and magnetic field hybrid coupling, and helps flexibly adjust high-frequency rejection performance or low-frequency rejection performance of the antenna 10.

A difference from the antenna 10 shown in FIG. 28 lies in that, in the antenna 10 shown in FIG. 29 and FIG. 30, a resonator 150 may include a plurality of portions with different extension directions. Therefore, this helps increase a size of the antenna 10 in a direction perpendicular to a reflection plate 12, and helps enable the antenna 10 to have relatively wide bandwidth.

The resonator 150 may include a portion 151, a portion 152, and a portion 153. The portion 151 may be symmetric to the portion 152 relative to the plane of symmetry 21. The portion 153 may be mechanically connected between the portion 151 and the portion 152. An extension direction of the portion 153 may be different from an extension direction of the portion 151, and the extension direction of the portion 153 may be different from an extension direction of the portion 152. The portion 153 may be symmetric relative to the plane of symmetry 21. In some embodiments, both the portion 151 and the portion 152 may extend from the portion 153 toward the resonator 110. The portion 153 may be disposed close to the reflection plate 12, to help receive a feeding signal. In a possible case, with reference to FIG. 3, FIG. 29, and FIG. 30, a transmission line 190 of a feeder network 3 may feed power on the portion 153. In other words, the portion 153 may be configured to receive feeding. A feeding location on a portion 113 is adjusted, so that bandwidth of the antenna 10 can be adjusted.

In the embodiments shown in FIG. 29 and FIG. 30, the resonator 150 may further include a portion 154 and a portion 155. The portion 154 may be mechanically connected to an end of the portion 151 away from the portion 153. The portion 155 may be mechanically connected to an end of the portion 152 away from the portion 153. The portion 154 may be symmetric to the portion 155 relative to the plane of symmetry 21. The portion 154 of the resonator 150 may be disposed close to a portion 113 of the resonator 110 and away from the reflection plate 12. The portion 155 of the resonator 150 may be disposed close to the portion 113 of the resonator 110 and away from the reflection plate 12. The resonator 150 may be coupled to the resonator 110 through the portion 154 and the portion 155.

In the embodiments shown in FIG. 29 and FIG. 30, both the portion 151 and the portion 152 may be parallel to the plane of symmetry 21. In another embodiment, both the portion 151 and the portion 152 may be oblique to the plane of symmetry 21. Placement angles of the portion 151 and the portion 152 relative to the plane of symmetry 21 are adjusted. This helps flexibly adjust electrical lengths of the portion 153, the portion 154, and the portion 155 when an overall electrical length of the resonator 150 basically remains unchanged, helps enable coupling strength between the resonator 150 and the resonator 110 to meet a requirement, and helps relatively flexibly adjust the feeding location on the portion 153, to meet a bandwidth requirement of the antenna 10.

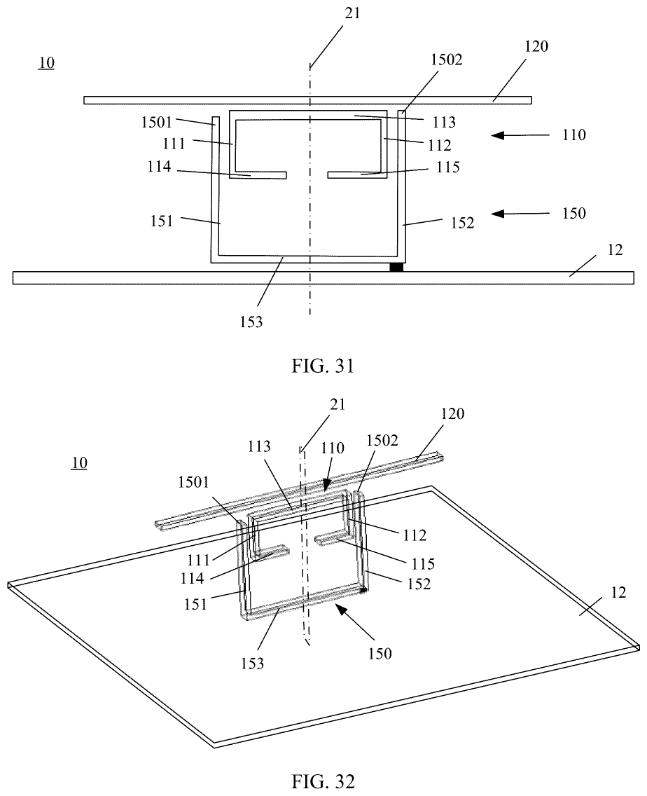

FIG. 31 is a diagram of a structure of an antenna 10 according to an embodiment of this application. The diagram of the structure shown in FIG. 31 may be a front view of the antenna 10. FIG. 32 is a three-dimensional diagram of the antenna 10 shown in FIG. 31.

A difference from the embodiments shown in FIG. 29 and FIG. 30 lies in that, in the embodiments shown in FIG. 31 and FIG. 32, a resonator 150 may not include the portion 154 and the portion 155 shown in FIG. 29 and FIG. 30. An end of a portion 151 away from a portion 153 may be an open end 1501 of the resonator 150. An end of a portion 152 away from the portion 153 may be an open end 1502 of the resonator 150.

A portion 113 of a resonator 110 may be disposed close to a resonator 120 and away from a reflection plate 12. A portion 111 and a portion 112 of the resonator 110 may extend from the portion 113 toward the reflection plate 12 and away from the resonator 120. The resonator 110 may be coupled to the resonator 120 through the portion 113. The portion 151 of the resonator 150 may extend from the portion 153 to a side of the portion 111 of the resonator 110, and the portion 151 of the resonator 150 may be coupled to the portion 111 of the resonator 110. The portion 152 of the resonator 150 may extend from the portion 153 to a side of the portion 112 of the resonator 110, and the portion 152 of the resonator 150 may be coupled to the portion 112 of the resonator 110.

In the embodiments shown in FIG. 31 and FIG. 32, the portion 151 of the resonator 150 may extend from the portion 153 toward the resonator 120. The end of the portion 151 away from the portion 153, namely, the open end 1501 of the resonator 150, may be disposed close to the resonator 120. The portion 152 of the resonator 150 may extend from the portion 153 toward the resonator 120. The end of the portion 152 away from the portion 153, namely, the open end 1502 of the resonator 150, may be disposed close to the resonator 120. The resonator 150 may be coupled to the resonator 120 through the open end 1501 and the open end 1502. The resonator 150 may be coupled to both the resonator 110 and the resonator 120. Therefore, this helps enable the antenna 10 to have relatively many coupling modes, and helps improve filtering performance of the antenna 10.

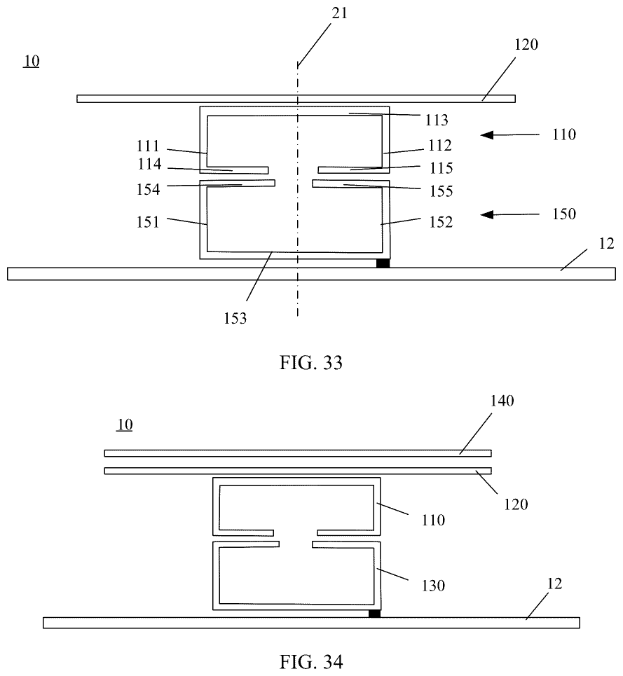

FIG. 33 is a diagram of a structure of an antenna 10 according to an embodiment of this application. The diagram of the structure shown in FIG. 33 may be a front view of the antenna 10. For a three-dimensional structure of a resonator 110, refer to the resonator 110 shown in FIG. 32. For a three-dimensional structure of a resonator 150, refer to the resonator 110 shown in FIG. 30.

A difference from the antenna 10 shown in FIG. 29 and FIG. 30 lies in that, in the antenna 10 shown in FIG. 33, a portion 114 and a portion 115 of the resonator 110 may be disposed close to the resonator 150 and away from a resonator 120. A portion 113 of the resonator 110 may be disposed close to the resonator 120 and away from the resonator 150. Projection is performed in a direction parallel to a plane of symmetry 21 and perpendicular to a reflection plate 12, and a projection area of the portion 113 may be larger than a total projection area of the portion 114 and the portion 115. Therefore, this helps improve coupling strength between the resonator 110 and the resonator 120.

FIG. 34 is a diagram of a structure of an antenna 10 according to an embodiment of this application. The diagram of the structure shown in FIG. 34 may be a front view of the antenna 10.

Compared with the antenna 10 shown in FIG. 33, the antenna 10 shown in FIG. 34 may further include a resonator 140, and the resonator 140 may be located on a side of a resonator 120 away from a reflection plate 12. The resonator 140 may be coupled to the resonator 120. As described in the embodiment shown in FIG. 33, coupling strength between a resonator 110 and the resonator 120 is relatively high, and strength of a signal of the resonator 140 excited by the resonator 110 or the resonator 120 may be relatively strong. This helps improve a gain of the antenna 10.

In a similar way as the embodiment shown in FIG. 12 or FIG. 34, with reference to FIG. 4 to FIG. 10 and FIG. 13 to FIG. 31, in some embodiments provided in this application, the antenna 10 may further include the resonator 140, and the resonator 140 may be located on the side of the resonator 120 away from the reflection plate 12. The resonator 140 may be coupled to the resonator 120. For specific descriptions of the resonator 140, refer to the embodiment shown in FIG. 12 or FIG. 34.

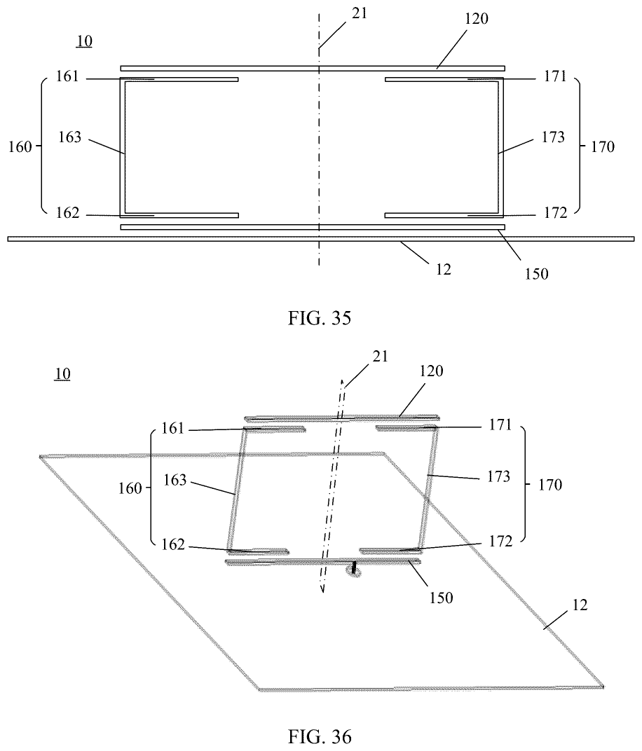

FIG. 35 is a diagram of a structure of an antenna 10 according to an embodiment of this application. The diagram of the structure shown in FIG. 35 may be a front view of the antenna 10. FIG. 36 is a three-dimensional diagram of the antenna 10 shown in FIG. 35.

In the embodiments shown in FIG. 35 and FIG. 36, the antenna 10 may include a resonator 150, a resonator 160, a resonator 170, a resonator 120, and a reflection plate 12. The resonator 150 may be located on a side of the reflection plate 12 close to the resonator 120. Both the resonator 160 and the resonator 170 may be located between the resonator 120 and the resonator 150. The resonator 150 may be coupled to the resonator 160 and the resonator 170. The resonator 160 may be coupled to the resonator 120. The resonator 170 may be coupled to the resonator 120. The resonator 150 is symmetric relative to a plane of symmetry 21. The resonator 160 may be symmetric to the resonator 170 relative to the plane of symmetry 21. The resonator 160 may include a plurality of portions with different extension directions. The resonator 170 may include a plurality of portions with different extension directions. The resonator 160 and the resonator 170 each include a plurality of portions with different extension directions. Therefore, this helps enable the antenna 10 to have a relatively proper size in a direction perpendicular to the reflection plate 12, and helps enable bandwidth of the antenna 10 to meet a use requirement.

In the embodiments shown in FIG. 35 and FIG. 36, the resonator 160 may include a portion 161, a portion 162, and a portion 163. The portion 163 may be directly mechanically connected between the portion 161 and the portion 162. An extension direction of the portion 163 is different from an extension direction of the portion 161. The extension direction of the portion 163 is different from an extension direction of the portion 162.

In the embodiments shown in FIG. 35 and FIG. 36, the resonator 170 may include a portion 171, a portion 172, and a portion 173. The portion 173 may be directly mechanically connected between the portion 171 and the portion 172. An extension direction of the portion 173 is different from an extension direction of the portion 171. The extension direction of the portion 173 is different from an extension direction of the portion 172.

The portion 161 of the resonator 160 may be symmetric to the portion 171 of the resonator 170 relative to the plane of symmetry 21. The portion 162 of the resonator 160 may be symmetric to the portion 172 of the resonator 170 relative to the plane of symmetry 21. The portion 163 of the resonator 160 may be symmetric to the portion 173 of the resonator 170 relative to the plane of symmetry 21.

The resonator 160 may be coupled to the resonator 120 through the portion 161. The resonator 160 may be coupled to the resonator 150 through the portion 162. The resonator 170 may be coupled to the resonator 120 through the portion 171. The resonator 170 may be coupled to the resonator 150 through the portion 172.

In some embodiments, the portion 161 and the portion 162 may be perpendicular to the plane of symmetry 21. Therefore, this helps improve coupling strength between the resonator 160 and the resonator 150 and coupling strength between the resonator 160 and the resonator 120.

In some embodiments, the portion 171 and the portion 172 may be perpendicular to the plane of symmetry 21. Therefore, this helps improve coupling strength between the resonator 170 and the resonator 150 and coupling strength between the resonator 170 and the resonator 120.

In some embodiments, an end of the portion 161 away from the portion 163 and an end of the portion 162 away from the portion 163 may be two open ends of the resonator 160. An end of the portion 171 away from the portion 173 and an end of the portion 172 away from the portion 173 may be two open ends of the resonator 170. Therefore, this helps enable that relatively many portions of the resonator 160 and the resonator 170 can be disposed close to the resonator 120 or the resonator 150, to enhance the coupling strength between the resonator 160 and the resonator 120, between the resonator 170 and the resonator 120, between the resonator 160 and the resonator 150, and between the resonator 170 and the resonator 150.

To enable the antenna 10 to work in an operating frequency band, an electrical length of the resonator 160 may be similar to or the same as an electrical length of the resonator 170. In some embodiments, the electrical length of the resonator 160 may be (¼ to ¾)λ, for example, 2/2; and the electrical length of the resonator 170 may be (¼ to ¾)λ, for example, λ/2, where λ is a wave length corresponding to a center frequency of the operating frequency band of the antenna. In a possible case, a difference between the electrical length of the resonator 160 and the electrical length of the resonator 170 is less than λ/4.

To enable energy transfer efficiency between the resonator 120 and the resonator 160 to be relatively high, the resonator 120 and the resonator 160 may be as close as possible. To enable energy transfer efficiency between the resonator 120 and the resonator 170 to be relatively high, the resonator 120 and the resonator 170 may be as close as possible. In some embodiments, a spacing between the resonator 120 and the resonator 160 is less than λ/5, λ/8, λ/10, or λ/15, and a spacing between the resonator 120 and the resonator 170 is less than λ/5, λ/8, λ/10, or λ/15, where λ is the wave length corresponding to the center frequency of the operating frequency band of the antenna 10.

To enable energy transfer efficiency between the resonator 150 and the resonator 160 to be relatively high, the resonator 150 and the resonator 160 may be as close as possible. To enable energy transfer efficiency between the resonator 150 and the resonator 170 to be relatively high, the resonator 150 and the resonator 170 may be as close as possible. In some embodiments, a spacing between the resonator 150 and the resonator 160 is less than λ/5, λ/8, λ/10, or λ/15, and a spacing between the resonator 150 and the resonator 170 is less than λ/5, λ/8, λ/10, or λ/15, where λ is the wave length corresponding to the center frequency of the operating frequency band of the antenna 10.

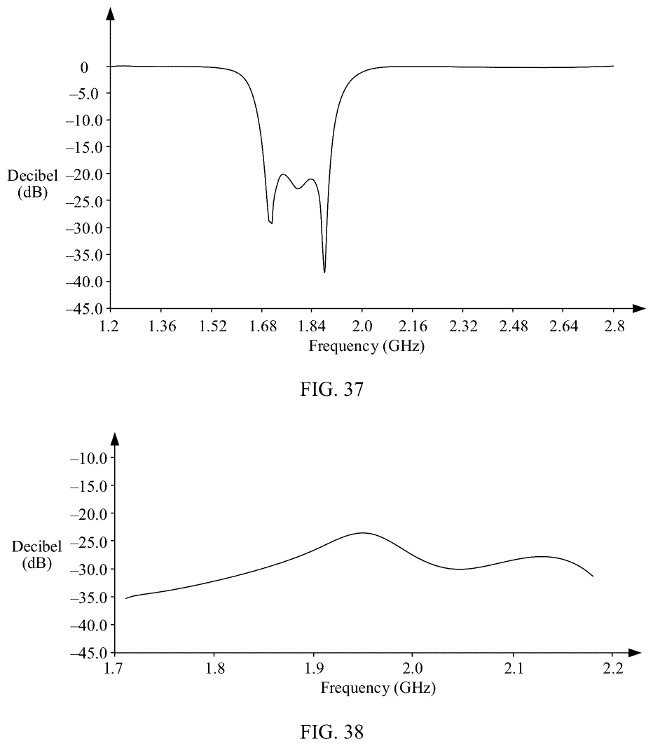

FIG. 37 is a diagram of a reflection coefficient according to an embodiment of this application. In FIG. 37, a horizontal coordinate is an operating frequency, and a unit of the operating frequency is megahertz GHz; and a vertical coordinate is the reflection coefficient, and a unit of the reflection coefficient is decibel.

According to embodiments provided in this application, the reflection coefficient can be less than-15 dB within 1.68 to 1.92 GHz. An antenna 10 may have a relatively good reflection coefficient within 1.68 to 1.92 GHz. Therefore, a frequency band within 1.68 to 1.92 GHz may serve as an operating frequency band of the antenna 10. A plurality of resonators of the antenna 10 may be in an open field, an unloaded Q value is relatively high, a dielectric loss is relatively small, and an overall loss of the antenna 10 is relatively low. Therefore, it is relatively easy to implement a relatively high gain.

Outside the operating frequency band, especially in a specified filtering frequency band adjacent to the operating frequency band, a slope in the diagram of the reflection coefficient of the antenna 10 is relatively steep, which means that the antenna 10 may have relatively good filtering performance in the specified filtering frequency band adjacent to the operating frequency band. This helps reduce strength of a signal received by the antenna 10 in the specified filtering frequency band. In other words, embodiments provided in this application facilitate relatively good performance in terms of the reflection coefficient, filtering performance, and the like.

FIG. 38 is a diagram of isolation of an antenna 10 having dual polarization performance according to this application. FIG. 38 is a diagram of isolation within 1.7 to 2.2 GHz (horizontal coordinate), where a vertical coordinate is the isolation and in a unit of decibel.

According to embodiments provided in this application, the isolation can be less than −25 dB within 1.7 to 2.2 GHz. The antenna 10 may have relatively good isolation within 1.7 to 2.2 GHz. In other words, embodiments provided in this application facilitate relatively good performance in terms of the isolation.

This application provides an antenna, a communication device, and a communication system. The antenna includes a plurality of resonators, and the plurality of resonators are coupled to each other. The plurality of resonators may have symmetry, and at least one of the plurality of resonators has a plurality of portions with different extension directions. Structures of the plurality of portions are properly designed, which helps enable the antenna to have relatively good performance in terms of bandwidth, a gain, isolation, a reflection coefficient, filtering performance, and the like, and helps the antenna meet more requirements.

The foregoing descriptions are merely specific implementations of this application, but are not intended to limit the scope of the protection of this application. Any variation or replacement readily figured out by a person skilled in the art within the technical scope disclosed in this application shall fall within the scope of the protection of this application. Therefore, the scope of the protection of this application shall be subject to the scope of the protection of the claims.

1. An antenna, comprising:
a first resonator, a second resonator, and a reflection plate, wherein the first resonator is located between the reflection plate and the second resonator, the first resonator is coupled to the second resonator, the first resonator is symmetric relative to a first plane of symmetry, the first resonator comprises a plurality of portions, and extension directions of the plurality of portions are different.

2. The antenna according to claim 1, wherein the first resonator comprises a first portion, a second portion, and a third portion, the first portion is mechanically connected between the second portion and the third portion, the first portion is symmetric relative to the first plane of symmetry, the second portion is symmetric to the third portion relative to the first plane of symmetry, and the second portion extends from the first portion away from the second resonator.

3. The antenna according to claim 2, wherein an end of the second portion away from the first portion is an open end of the first resonator.

4. The antenna according to claim 2, wherein the first resonator further comprises a fourth portion and a fifth portion, the fourth portion is mechanically connected to an end of the second portion away from the first portion, the fifth portion is mechanically connected to an end of the third portion away from the first portion, and the fourth portion is symmetric to the fifth portion relative to the first plane of symmetry.

5. The antenna according to claim 4, wherein the fourth portion extends from the second portion away from the third portion.

6. The antenna according to claim 2, wherein the second portion or the third portion is:
perpendicular to the first portion; or
oblique to the first portion.

7. The antenna according to claim 1, wherein the antenna further comprises a third resonator, the third resonator is symmetric relative to the first plane of symmetry, the third resonator is disposed on a side of the first resonator away from the second resonator, and the third resonator is coupled to the first resonator.

8. The antenna according to claim 7, wherein the third resonator is further coupled to the second resonator.

9. The antenna according to claim 7, wherein the third resonator comprises a sixth portion and a seventh portion, extension directions of the sixth portion and the seventh portion are different, the sixth portion is coupled to the first resonator, and the seventh portion is configured to receive feeding.

10. The antenna according to claim 1, wherein the second resonator is symmetric relative to a second plane of symmetry.

11. The antenna according to claim 10, wherein the first plane of symmetry and the second plane of symmetry are coplanar.

12. The antenna according to claim 1, wherein projection is performed in a direction parallel to the first plane of symmetry and perpendicular to the reflection plate, and a projection region of the first resonator at least partially overlaps a projection region of the second resonator.

13. The antenna according to claim 12, wherein the projection region of the first resonator is located inside the projection region of the second resonator.

14. The antenna according to claim 1, wherein the antenna further comprises a fourth resonator, the fourth resonator is located on a side of the second resonator away from the first resonator, and the fourth resonator is coupled to the second resonator.

15. The antenna according to claim 1, wherein the antenna has a first feeding location and a second feeding location, and the first feeding location is symmetric to the second feeding location relative to the first plane of symmetry.

16. The antenna according to claim 1, wherein an electrical length of the first resonator is (¼ to ¾)λ, and λ is a wave length corresponding to a center frequency of an operating frequency band of the antenna.

17. The antenna according to claim 1, wherein an electrical length of the second resonator is (¼ to ¾)λ, and λ is a wave length corresponding to a center frequency of an operating frequency band of the antenna.

18. The antenna according to claim 1, wherein the second resonator is a radiating element of the antenna.

19. The antenna according to claim 1, wherein the antenna further comprises a fifth resonator, the fifth resonator is coupled to the second resonator, the fifth resonator is symmetric relative to a third plane of symmetry, the third plane of symmetry is perpendicular to the first plane of symmetry, and a polarization direction of the fifth resonator and a polarization direction of the first resonator are orthogonal to each other.

20. A communication device, comprising:
an antenna, wherein the antenna comprises a first resonator, a second resonator, and a reflection plate, wherein the first resonator is located between the reflection plate and the second resonator, the first resonator is coupled to the second resonator, the first resonator is symmetric relative to a first plane of symmetry, the first resonator comprises a plurality of portions, and extension directions of the plurality of portions are different.
